(19) United States
(12) Patent Application Publication
(10) Pub. No.: US 2015/0057994 A1
(43) Pub. Date: Feb. 26, 2015

(54) Unified Mobile Learning Platform

(71) Applicants: Eric Hong Fang, League City, TX (US); Ling Fang, Beijing (CN); Shenggang Fan, Beijing (CN); Lifeng Jin, Beijing (CN); Shengzhong Zhang, Beijing (CN)

(72) Inventors: Eric Hong Fang, League City, TX (US); Ling Fang, Beijing (CN); Shenggang Fan, Beijing (CN); Lifeng Jin, Beijing (CN); Shengzhong Zhang, Beijing (CN)

(21) Appl. No.: 14/462,692

(22) Filed: Aug. 19, 2014

Related U.S. Application Data
(60) Provisional application No. 61/867,829, filed on Aug. 20, 2013.

(51) Int. Cl. G09B 19/06; G06F 17/27; H04W 4/14; G06F 17/28

(52) U.S. Cl. CPC G09B 19/06; G06F 17/289; G06F 17/2735; G06F 17/2836; G06F 17/273; H04W 4/14
USPC 704/4; 704/2

(57) ABSTRACT

A translation and teaching system for sending text messages over a telecommunication pathway sent by users in a first language received by a server, a comparison database of a second language for matching, converting the text into a second language upon making the match, a translator for converting the first text transmission into the second language if no match is made into a second transmission, a processor in the server for analyzing the conversion of the transmission for accuracy, and a data path to send the transmission to the user. The system may have a pre-processor that recognizes linguistic irregularities and modifies them to conform to the second language's pre-stored standard grammar and a human linguist platform for post verification of the translation. The system also generates learning lessons for user in language, a learning dictionary that groves with user input, and the addition of third party content for lessons.

### CROSS REFERENCE TO RELATED APPLICATIONS

This application takes priority from provisional application for patent Ser. No. 61/867,829 filed Aug. 20, 2013 entitled “Method and Apparatus for a Unified Mobile Learning Platform” and is incorporated as if fully set forth herein.

### FIELD OF THE INVENTION

The present invention relates to translation systems and more particularly to a text messaging translation and teaching system.

### DESCRIPTION OF ATTACHED APPENDIX

Not Applicable.

### BACKGROUND OF THE INVENTION

The Unified Mobile Learning Platform, mLP 124 of FIG. 1, of the present invention incorporates at least four processes that seamlessly integrate mobile application, translation, education courseware and learner management system to form a complete mobile language education and translation technology delivery platform: the Mobile Translation Optimization Process (ATOP), the Mobile Learning System Process (MLSP), the Mobile Learning Product Development (mLP 124D) and the Mobile Content Delivery Process (MCDP).

The Unified Mobile Learning Platform mLP 124 system is an open architecture, integrating different education resources and making it available in mobile format to present on mobile terminals, through content adoption, reorganization, re-editing and conversion. Standardization is another key feature where the system supports standard protocols and open interfaces, seamlessly working with all mobile phone users under different operators' network environment. The system is a scalable and Modular-based platform and supports a Telecom grade service with upwards to 99.99% reliability.

The term mobile learning covers a range of use scenarios including earning, education technology and distance education that focuses on learning with mobile devices, and with the use of mobile devices, learners can learn anywhere and at anytime.

There are three core areas of mobile learning, including, Authorizing and Publishing, Delivery and Tracking, and Content Development.

### BRIEF SUMMARY OF THE INVENTION

The present invention includes different mobile learning services, such as mobile language courses, study aid mobile searching and mobile digital publishing material.

The present invention incorporates all three mobile approaches—push, pull and interactive—to create a unique mobile translation and learning experience customized to the subscriber. With the use of the present invention, all of the services and learning courses can be delivered to a variety of mobile operating systems and devices.

Mobile learning has been in the spotlight ever since day one of its birth as a new learning mode. In the era of mobile Internet when everything online is going mobile, learning is also trying to find a more portable, easy to use and colorful gateway to present to its recipients. From early lab experiments to current products in the market, mobile learning has developed rapidly. More and more people accept the idea of learning on the go, and they embrace the experience mobile learning provides them, when they want or need it. This unique experience, as defined by the present invention is freedom.

In order to provide users with a complete mobile learning experience, the present invention utilizes a mobile learning system and uses this as the starting point where all services are located and also as the basic technical structure for the expression of theories of mobile learning. For users, what they need from the system is content delivery, interaction management and progress management. For content providers, what they need from the system is content management, user management and user data analysis, all of which has been included into the present invention.

Content Integration. Content is generated from various sources such as users, content providers and MLS itself. MLS collects all sorts of content and integrates it with predefined principles and rules in order to make all of them accessible and meaningful to all parties. This content includes learning materials, user-generated content and information as well as MLS-generated information. The learning materials need to be organized into different packages to form different kinds of lessons and courses, user-generated content, MLS-generated information and learning materials need to be put together to provide useful information for the creation of user progress, user preferences, user learning modes, content delivery preferences, user groups etc.

Channel Adaptation. Content is designed to be delivered through different mobile channels, such as SMS, MMS, IVR, WAP and client, so MLS provides tools and procedures to edit and compile the content in the system to be delivered in different forms as required, including text, pictures, mixtures of them, audio, and video. Therefore, different kinds of content, such as text, pictures, audio, video, interactive voice response, etc, can be sent to users in the channel whichever is the most suitable for doing so. All of the adaptation procedures are customizable so that MLS can easily adapt different technical standards provided by different operators around the world.

Artificial Intelligence (AI)-powered Progression Tracking. One of the main features MLS provides is its powerful AI-powered user data analysis system. The engines in MLS can provide users detailed information as what they are doing, how they are doing, how long they will continue to do it and what type of learner they are. Users cannot only get information regarding their lessons and courses, but also information about themselves. Through data mining and in-depth analysis, as well as, ample knowledge of mobile learner behavioral studies, MLS puts all the moves that users make together and creates profiles that guide both the user's learning activities and MLS's learning content organization and delivery.

Communication and Social Interaction. Communication and social interaction are important aspects in learning in a natural environment, so they also need to be in MLS. Modules of MLS are designed specifically for this purpose. They take data from all parts of MLS and help users to find their partners or friends to help study. MLS utilizes as many communication channels as possible to provide a wide range of interacting activities and opportunities.

In accordance with a preferred embodiment of the invention, there is shown a translation system for sending messages over a telecommunication pathway having a first text SMS transmission sent by a user on a transmission path of a telecommunication provider in a first language received by a server, a comparison database on the server of a second language for matching with the transmission in the first language, a converter in the database for converting the transmission into a second language upon making the match, a translator for converting the first transmission into the second language if no match is made into a second transmission, a processor in the server for analyzing the conversion of the transmission for accuracy, and a data path for the second transmission on the carrier for the telecommunication provider to send the transmission to the user.

In accordance with another preferred embodiment of the invention, there is shown a computerized translation system having a server for reception of a message to be translated over a telecommunication pathway, a language module on the server that configures a first and second language pair for machine translation, a language calling module that calls translation language modules on the server for matching of the language pairs, a real-time translator on a server that translates the message from a source language text to target language text, a translation evaluator that checks the accuracy of each translation result to make sure it is a serviceable translation, and delivery of the translation result to a user.

In accordance with yet another preferred embodiment of the invention, there is shown a computerized translation method on a SMS/MMS gateway having the steps of translating a message delivered to a server from a user through an SMS/MMS gateway between two languages to recognize a first language message and translate it into a target second language, pre-processing on the server that recognizes linguistic irregularities, including lexical errors, misspellings, syntactical errors and synonyms and modifies the irregularities to conform to the second language's pre-stored standard grammar, delivery of the machine translated message to a human linguist platform for post verification that operates on the machine translation for review and delivery to the SMS/MMS gateway of the finished translation to the user, a translation evaluator that checks the accuracy of each translation result to make sure it is a serviceable translation, and delivery of the translation result to a user.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows a block diagram of a preferred embodiment of the present invention.

FIG. 2 shows a block diagram of a module of a preferred embodiment of the present invention.

FIG. 3 shows a block diagram of a module of a preferred embodiment of the present invention.

FIG. 4 shows a block diagram of a module of a preferred embodiment of the present invention.

FIG. 5 shows a block diagram of a module of a preferred embodiment of the present invention.

FIG. 6 shows a block diagram of a module of a preferred embodiment of the present invention.

FIG. 7 shows a block diagram of a module of a preferred embodiment of the present invention.

FIG. 8 shows a block diagram of a module of a preferred embodiment of the present invention.

FIG. 9 shows a block diagram of a module of a preferred embodiment of the present invention.

FIG. 10 shows a block diagram of a module of a preferred embodiment of the present invention.

FIG. 11 shows a block diagram of a translation system of a preferred embodiment of the present invention.

FIG. 12A shows a block diagram of a translation system of a preferred embodiment of the present invention.

FIG. 12B shows a block diagram of a translation system of a preferred embodiment of the present invention.

FIG. 12C shows a flow chart of a translation system of a preferred embodiment of the present invention.

FIG. 12D shows a flow chart of a translation system of a preferred embodiment of the present invention.

FIG. 12E shows a flow chart of a translation system of a preferred embodiment of the present invention.

FIG. 13A shows a block diagram of a translation system of a preferred embodiment of the present invention.

FIG. 13B shows a flow chart of a translation system of a preferred embodiment of the present invention.

FIG. 14 shows a flow chart of a translation system of a preferred embodiment of the present invention.

FIG. 15 shows a flow chart of a translation system of a preferred embodiment of the present invention.

FIG. 16 shows a flow chart of a translation system of a preferred embodiment of the present invention.

FIG. 17 shows a flow chart of a translation system of a preferred embodiment of the present invention.

### DETAILED DESCRIPTION OF THE PREFERRED EMBODIMENTS

Detailed descriptions of the preferred embodiments are provided herein. It is to be understood, however, that the present invention may be embodied in various forms. Various aspects of the invention may be inverted, or changed in reference to specific part shape and detail, part location, or part composition. Therefore, specific details disclosed herein are not to be interpreted as limiting, but rather as a basis for the claims and as a representative basis for teaching one skilled in the art to employ the present invention in virtually any appropriately detailed system, structure or manner

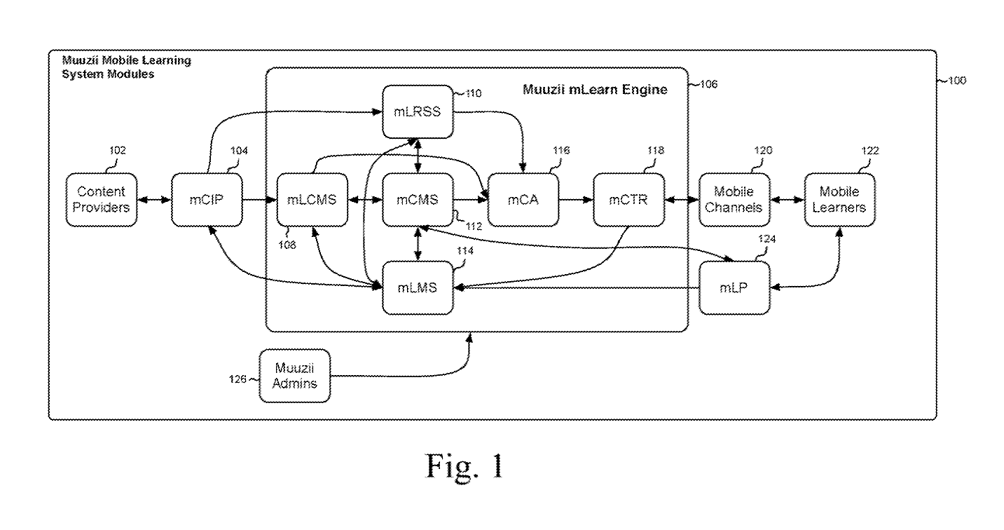

Turning now to FIG. 1, Muuzii Mobile Learning System Modules 100, is a platform specifically designed for mobile learning services, MLS is a multi-modular system with various functions. The whole system consists of three major parts, namely mCIP (Mobile Content Integrator Platform) 104, Muuzii mLearn Engine 106 and mLP (Mobile Learner Platform) 124.

All of the three major modules are interrelated to form the full circle of mobile learning. Each module, especially the engine, consists of smaller modules, so that most of their major functions are modularized and are able to be customized according to research, analysis and other requirements.

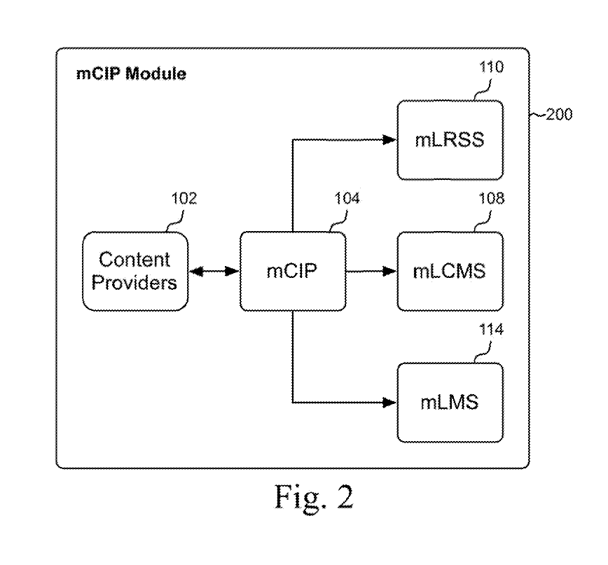

Turning now to FIG. 2, mCIP Module 200, mCIP 104 is the mobile content integrator platform. This is a platform provided to Content Providers 102. This module receives learning content from content providers, helps them to organize all the learning content and stores them into mLCMS (Mobile Learning Content Management System) 108. In addition, Content Providers 102 can provide different kinds of learning-related services through mCIP 104 and they, after registration and configuration, are sent to mLRSS (Mobile Learning-Related Service System) 110. mCIP 104 also receives user data and other user-related information from mLMS (Mobile Learner Management System) 114 to provide to the Content Providers 102 for performance references, and also sends information to mLMS 114 for user management and grouping.

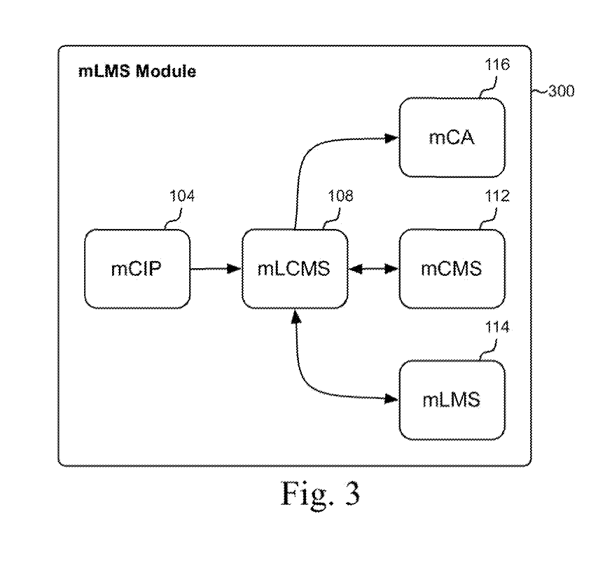

Turning now to FIG. 3, mLMS Module 300, mLCMS 108 is the mobile learning content management system. In this module, all learning content is managed and stored. All the content is categorized, stored in databases with standards provided by Muuzii and combined in a specific order that content with connections are naturally close. All content is from mCIP 104. After the content enters the mLCMS 108, the interaction between mLCMS 108 and mCMS (mobile course management system) 112 begins. mLCMS 108 sends information regarding content and initial content organization to mCMS 112 and mCMS 12 sends out instructions to mLCMS 108 as what content or what parts of content is currently needed for mobile course organization. mLMS 114 also interacts with mLCMS 108 by allowing users to create or modify content stored in mLCMS 108 through mLMS 114. mCA (mobile channel adaptors) 116 mostly takes the content out of mLCMS 108 and transform the standardized content into channel-specific materials.

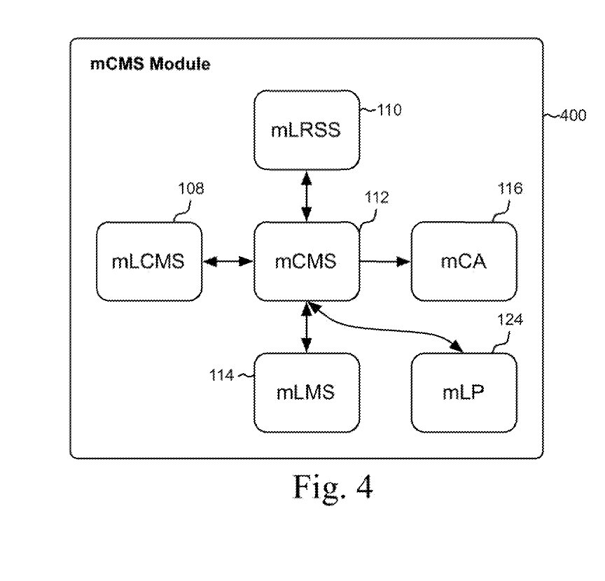

Turning now to FIG. 4, mCMS Module 400, mCMS 112 is mobile course management system. mCMS 112 provides a set of generating and transforming rules. mCMS 112 allows all content to be grouped and regrouped into different courses, regardless of the size of the content. Therefore it takes content from mLCMS 108 and takes course information and personal references from mLMS 114. Because learning-related services are also part of the mobile learning experiences, mLRSS 110 interacts with mCMS 112 so that learning-related services, such as translation services, dictionaries and other services can be integrated into the mobile learning courses. mCMS 112 also sends requests to mCA 116 to help mCA 116 to take content according to the rules set by users, mLP (mobile learner platform) 124 displays all user-related course information.

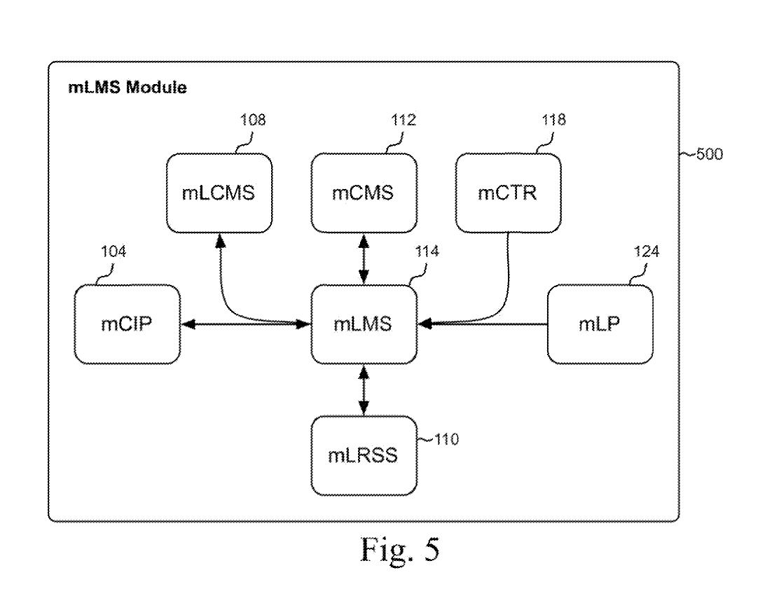

Turning now to FIG. 5, mLMS Module 500, mLMS 114 is the mobile learner management system. mLMS 114 collects all that is related to the users, and helps to manage all data that is generated by the users. mLMS 114 also sends out requests to all modules related to help customize what the users get. mLMS 114 interacts with mCMS 112, mLCMS 108 and mLRSS 110 to individualize the courses and content. mLMS 114 also receives information from mCTR (mobile content transmitter & receiver) 118 and mLP 124 to identify the users' needs and form requests for other modules based on the preferences users make. mLMS 114 also provides information to mCIP 104 for better understanding of current users for content providers.

mLMS 114 puts all information that is gathered from elsewhere together, and relies on a few AI engines, so when the information is processed, meaningful results will be given. mLMS 114 stores users' information, including contents, user interactions, replies, etc., as well as learning history, test results, social movements, subscriptions and cancellations. mLMS 114 then uses all the known history of the users as basic data for three different AI engines: History Evaluation System, Learning Mode Engine and User Mode Engine. History Evaluation System integrates all learning histories users make and transforms them into information that is needed by users, such as learning progress and evaluation of single or multiple courses, progression across all subscribed course and frequency and speed of learning of users. Learning Mode Engine also takes a lot of information from different modules, but what it focuses on is users' learning mode information, such as learning preferences, memory curves, learning modes, target setup and variable setup, so that from the traces users leave in the system, a whole picture of users' learning life can be portrayed. User Mode Engine, on the contrary, does not care about individuals. It deals with action modes of an entire user group, seeing a group of users as an individual or several individuals, thus creating profiles of entire user groups and exploring their mode of using different mobile learning services.

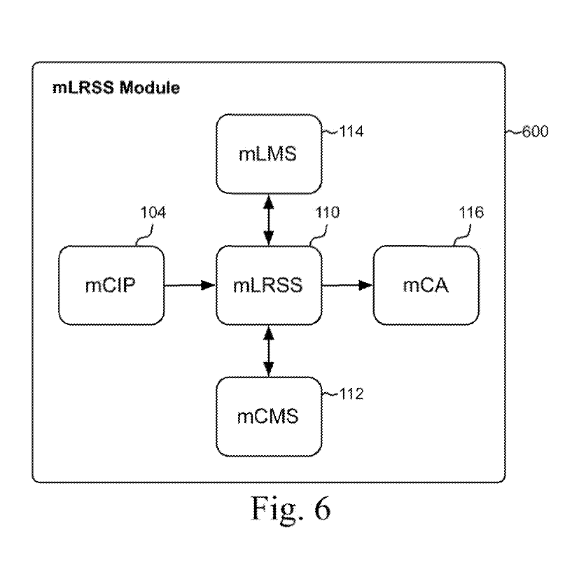

Turning now to FIG. 6, mLRSS Module 600, mLRSS 110 is the mobile learning-related service system. This system gives out different types of open ports for Content Providers 102 to provide learning-related services, such as translation, dictionaries, quizzes, games etc. mLRSS 110 shares many characteristics with mLCMS 108 except that it generally dynamically interacts with users, creating many user data. Therefore, mLRSS 110 is related to mLMS 114 for user data gathering and service individualization and mCMS 112 for course integration of different learning services. mCA 116 customizes what mLRSS 110 provides.

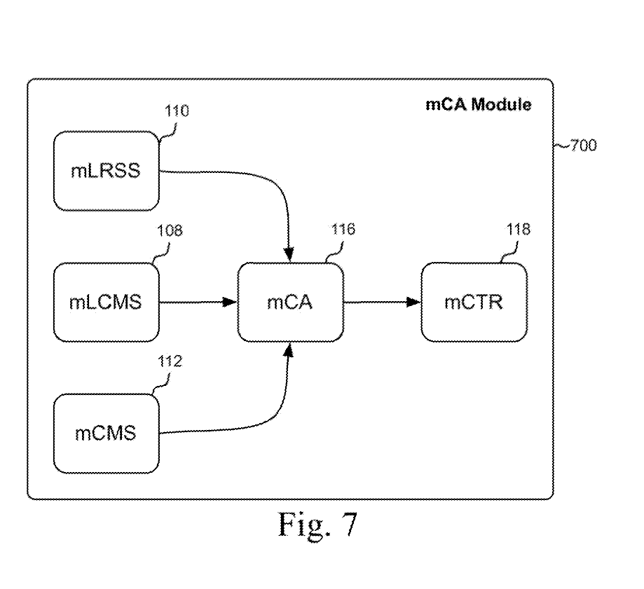

Turning now to FIG. 7, mCA Module 700, mCA 116 is mobile channel adaptors. This module converts all the standardized content and services into materials, which can be delivered through mobile channels, such as SMS, MMS, IVR, WAP etc. mCA 116 accepts channel information for courses from mCMS 112, and retrieves necessary content data from mLCMS 108 and mLRSS 110, converts it into the most suitable form, and then passes to mCTR 118 for content delivery.

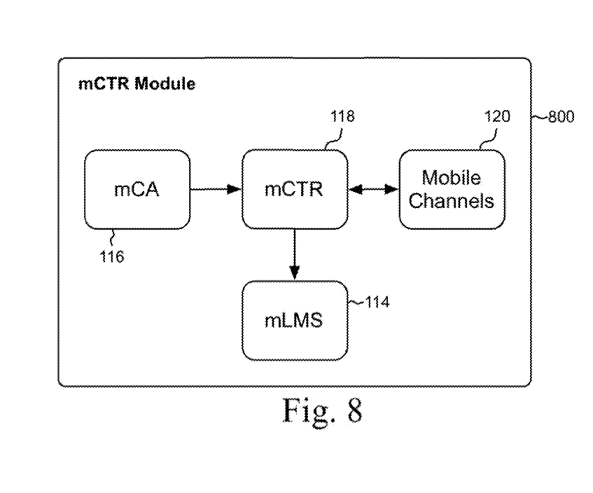

Turning now to FIG. 8, mCTR Module 800, mCTR 118 is the mobile content transmitter & receiver. This module sends out and accepts content from various sources. It helps to manage everything related to Mobile Channels 120, such as short code, push parameters, scheduled tasks etc. It receives content ready for push from mCA 116 and actually pushes the content down to users. It also receives what users upload and transports it to mLMS 114.

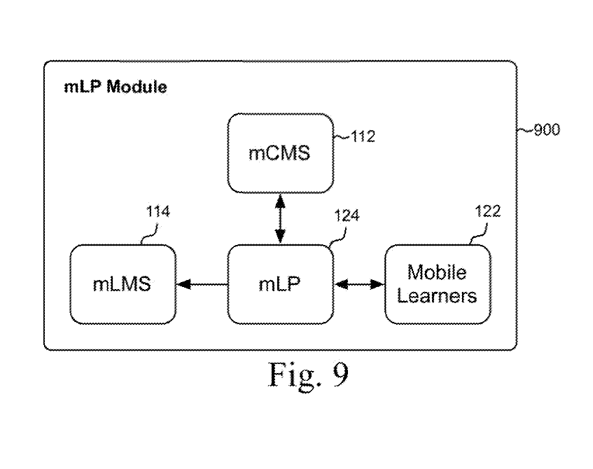

Turning now to FIG. 9, mLP Module 900, mLP 124 is the mobile learner platform. On the platform, all users need to know about their mobile learning is displayed, such as results from AI engines, content that they receive and create, courses they enroll in, progress of all their courses, preferences and topics, and socializing activities. mLP 124 provides users tools to customize what they choose to be their learning topics and send all the information to mCMS 112, also it accepts information and sends to mLMS 114 for more data collection.

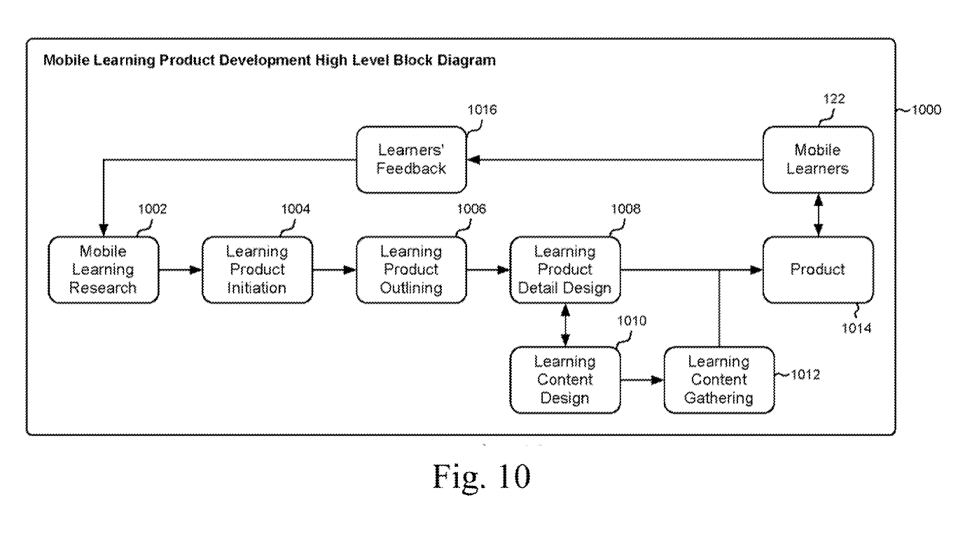

Turning now to FIG. 10, Mobile Learning Product Development High Level Block Diagram 1000, Muuzii Mobile Learning Product Development Process is a unique process that represents Muuzii's proprietary concept of incorporating teaching, learning, and assessment with mobile technologies. The Muuzii Mobile Learning Product Development Process focuses on mixing educational content collection and production together with standard mobile Internet product development. With this process, Muuzii is able to manufacture products, which provide high quality mobile educational contents and tools that are suitable for the mobile “eyeball” and screen. This process further allows Muuzii to create new innovative mobile Internet applications and services.

Muuzii Mobile Learning Product Development Process combines seven sub-processing methods:

To create mobile learning products, the very first of the process is Learning Product Initiation 1004. Generally, to start a product development process, it is crucial to first identify key points of the product. The initiation process researches a few important aspects of a product, understands what the key values are and sets the foundation for future development. This step includes initiating a process to update current products instead of making new ones. It is very important to keep existing products updated with research results and user behavior analyses from other sub-processes. The key aspects for the initiation process include Learner, Technology and Market. Learner represents the group of people who are or will be using the product, Technology is the technologies, which are going to be used in the new product or in the updated product, and Market is the commercial environment surrounding the learners. A detailed and accurate analysis of these processes is very valuable to the following processes, especially in the Learning Product Detailed Design 1008.

Learner is the first thing that comes to mind when initiating the product development process. Learners are the ones who will be using and experiencing learning products every day, so to identify who they are, what they need to learn and how they are currently learning the subject is very important. It is safe to say that the initial information constitutes the core of the new product and will be the primary principle for all the design procedures in the following processes.

Learner Group Targeting. The very first step of product initiation is to identify the learners. Currently, there are many groups of learners. With different grouping criteria, the grouping results can be very different. For example, they can be divided into groups with different age groups, such as primary school students, middle school students and college students, and they can be learning different subjects, such as English learners, IT learners, etc. It is important to choose one type of grouping approach and use it consistently.

For the following processes, the word ‘learner’ applies to specific learner groups, instead of the general learner.

Learner Behavior Analysis. With the specific group of learner chosen, the next task in line includes behavior analysis, needs analysis and profiling. Behavior Analysis includes the following aspects: what the group of learners usually learn in terms of subjects and fields; what they generally do when learning the subjects, i.e. have lessons on the subjects, learn by oneself, private tutor or other forms of learning and if they mix them together; what social bonds and power structures will occur within such learning structures; and what are the environmental factors connected with the learners, such as time spent, learning situation and other parameters.

These are the most important aspects of learner behavior and the analysis of these questions provides directional information to the design procedures and steps.

Learner Needs Analysis. Learner behavior is about how learners act in the learning environment, and learner need is why they choose to learn. Learning need means to identify goals, aims and expectations the learners wish to reach or gain from the learning activities. Most of the time, there is a central driver for all learning activities and the first task of need analysis is to identify the central drivers, and then look for secondary drivers to complete the basic need analysis.

The second task of need analysis is to look for the demands of the learners to the learning activities themselves. For example, one tries to learn Chinese because he wishes to setup a business relation with Chinese companies, but he also wishes that the Chinese courses be more practical so that he can spend less time writing and more time speaking. The need analysis needs to find out what learners think of the current learning courses, activities and approaches, and identifies defects and missing links within the current learning behaviors. In short, the second task is to understand what troubles the learners and hinders them from learning efficiently and effectively. Most of the inspirations of new products come from this process.

Learner Profiling. Learner profiling creates two profiles for the target group of learners: primary character profile and secondary character profile. The designer uses the analysis results from the above processes and puts them into two learner profiles. The profiles are detailed descriptions of two virtual characters, which are from the learner group and represent the whole learner group, not a real learner. The main character profile includes all the main characteristics of the group of learners, and the secondary character profile represents the needs from the minority groups within the learner group.

Technology. As the process is for producing mobile learning products, mobile technology is certainly one important aspect for consideration of product initiation. The technology choice for a product will determine the outlook of the product, the means of interaction between the learners and the product, the matching level of the technology with the learning activities, development difficulty level, and solutions to other product design issues. At the beginning stage of product development, it is important to go through all the technical possibilities now, and decide the best technical plan for the product with consideration of content display and learner interaction. For product updates, technology evaluation points out the direction where new features can be added or current features can be upgraded with new and better technological possibilities.

Technical Assessment. There are two tasks to complete in the process of technical assessment. The first task is to assess all the possible forms of technology. With the learner profiles, characteristics of the learning subjects, and with all the possible choices at hand, it is relatively easy to figure out the best choice for the subjects, i.e. the technology with the best learner experience, the best content presentation, the best learner interaction flow, the best progression control mechanism, etc.

The second task for technical assessment is to assess the development difficulty level of the chosen technology under a certain timeframe. Generally, the technology choices are ranked according to their usability, and ranked according to their level of difficulty for development. Therefore the technical assessment decides the technology the product is going to use, and evaluates the level of difficulty for development and estimates the time that will be spent on the development.

Mobile Delivery Analysis. For learning products, the central part is content Delivery of content from the product to the learners is then very important so this directly affects the experience of learners. In addition, because of the cloud computing properties of mobile learning products, the multiple delivery mechanism is also utilized often to achieve the best mobile learner coverage. In this sub-process, multiple delivery mechanisms are analyzed according to the learning subjects and contents, and useful information will be provided for technical assessment.

Market. Product development initiation is also about market analysis. The goal of a new product or an upgrade of a product is to attract more learners to use it. On one hand, more learners will benefit from the new product design concept and technology; on the other hand, the product will bring more revenue so that the upgrade process can be carried out after a period of market trials and commercial implementation. Therefore, for any product idea or design, the knowledge of current market is indispensable. There are four aspects of the market analysis. The current market consists of many products which may be alike to the initiating product; it is important to know how the learning activity is carried out traditionally without help of technology; thirdly, the analysis of risks lurking in the market is necessary; finally, how the product will bring new revenue is also predicted and designed in the overall market analysis process.

Competitor Analysis. For mobile learning products, the competitors are generally not coming from the mobile learning business, as the business is still small in scale, but from other areas such as the e-learning service providers, long distance education providers, education electronics manufacturers, sometimes even from publishers, training institutions and other offline organizations. Although small, the mobile learning industry also has new and interesting competitors coming to the surface every now and then. With the learner group and learning need analyses, the competitor analysis will be restricted to the products, which show a strong relationship to the product's target market. The analysis is composed by two different analyses.

Feature analysis: the features of the competitors should be analyzed. The features include the features in product promotional materials, as well as the features that are experienced and experienced by analysts' first-hand use. This gives a common feature list of the products in the market right now and the special features every product has which make them unique.

Comparative analysis: the defects of the products are listed and analyzed. Combined with the strong capabilities of the product team, the market niche may be found. This analysis tries to locate the weak points of the current competing products and looks for opportunities and niches.

Traditional Learning Approaches Analysis. Learning approaches are how the subjects are learned in terms of knowledge acquisition. The learning approach may consist of learning environment, course design, interaction design, assessment design, knowledge quantity design, learning pace design, etc. For education products, the learning method research is important as it plans a goal for the learners, designs pathways to reach the goal and shows when that goal is reached. For learners, learning effectively and efficiently is important, and the learning approach guarantees the learning process goes as planned. For any subject, there are learning approaches to tackle the problem of knowledge acquisition of certain type of learning material. The traditional ways of learning are analyzed in order to dig out the important elements of the approach mentioned above. Combined with mobile technology, this analysis will show the designers the aspects of the traditional learning approaches, which can be improved and innovated by mobile learning theories.

Risk Analysis. Risk analysis looks at all possible risks and hazards and creates preventive solutions. For mobile learning products, the risks may come from government policy and regulation changes, new mobile technology challenges, mobile device compatibility, etc.

Business Model Analysis. For any type of learner and technology, the business model is also limited. For SMS, the business model almost certainly involves carriers; for mobile Internet, the choices are wider and the carriers may not be the best options in terms of business model construction. The business model analysis looks at the business models of the competitors, the viable business models for the chosen technology and group of learners, and decides which ones may be the best choices for the initiating product.

With all the detailed analysis reports from the Learning Product Initiation 1004 process, abundant information is now at hand and the product may be designed and described to some extent. The Learning Product Outline 1006 process provides a top-level product design and description so that project participants may be able to see and feel the product. For the product outlining process, two sub-processes are included. The feature design process focuses on the feature list or the functions of the product, making sure that the product feature list is based on the market findings of the competitors and exceeds their capabilities. Demo creation is about creating a prototypical product so that the product designers may carry out the user experience tests.

The outlining process is a recurring process. The product outlining will be aiming at a complete and exhaustive design, and user experience testing will help to eliminate unreasonable features. This requires the process to happen several times in order to get a slimmer but more applicable product prototype with a full set of main functions and secondary functions.

Feature Design. Any function, characteristic or solution of a product may be termed a feature. The process of feature design selects and defines all the features of this new product according to learner group targeting, technology choice and market analysis. The features designed are the skeletal structures of the product yet it pictures the new product with clear outlines and promotional points so that all project participants may have a clear understanding of product direction.

Learning Feature Listing. When the product outlining process is carried out for the first time for a new product, all the possible features that suit the particular group of learners are listed. The features may come from the competitor analysis, traditional learning approach analysis, learner behavior and need analysis, or from original ideas. Preliminary selection may be used to exclude some unpractical features, but generally, at first the feature list need should be exhaustive. After the outlining process is run once, learners in UE tests may reduce the list. After several rounds of tests and reduction, the feature list may only contain the necessary functions to be developed in the current round of design and development processes.

Basic Interface Design. For every feature list, the interface of the product, i.e. how the features are arranged, how the texts are displayed and how the total product may look, is very important because it gives a clear vision of how the product with a certain feature list may look. The interface design is also a very simple but powerful tool, providing the stage for any discussion regarding to feature lists or user experiences. The basic interface also needs to be simple and prototypical so that it can be easily modified and updated with every feature list update. However, the basic interface serves as the skeletal design for the complete product design; therefore, it needs to be practical and user-friendly to achieve minimum redesigning work.

Interacting Logic Display. The interface will have to be interactive to be good to mimic the real product. This process is for the design of the interaction flows and logic for all the features in the feature list. This process requires the designer to make clear the logic between and within the features, and puts the flows as flowcharts, forms or block diagrams for viewers to understand the dynamics between the functions of the new product. This also changes with the feature list and serves as the basic logic flow design for the detailed logic design followed.

Learner & Market Specification. Although the target learner group and the market are analyzed and specified in the previous process, in the outlining, it is important to finalize the target learners and markets. The learner specification has to be very specific and very detailed, and the connections between the learner specification and the feature list will have to be explained so that the rationale behind the features may be fully understood by the viewers. In addition, the market specification also needs to be specific, detailing the size, the growth, the past and future status, as well as the connections between the market and the business models of the new product.

Product Evolution Analysis. Although it is still the outlining process, the product evolution needs to be analyzed. The evolution here bears two meanings. First, there will be many features in the feature list, which cannot get to the detailed design phase; therefore, these features will be put into the evolution analysis as possible future features and functions. This is the evolution of the current product. Second, the new product will have to develop connections to other existing products, therefore the whole product line, the overall product platform, etc. will evolve with the arrival of the new production. This is the evolution of the product line and platform. These two evolutionary paths need to be articulated in the analysis.

Content & Tool Combination Specification. In this process, the difference between content and tool is important. For any mobile learning product, it consists of two parts, one is for learners to read and learn, which is called content, and the other is tools and instruments which help the learners to read and learn efficiently, which is called tools. The combination of the two parts brings a complete and integrated learning solution to the learners. However, in the outlining and the designing processes, the content part and the tool part need to be described separately, and the way of combining them together will be described to ensure that the content part and the tool part remain separate but are also bond together organically.

Demo Creation. In many situations, demos are much better than basic interface as demos are prettier and more persuasive. Demos are generally required to be highly authentic, looking just like the finished product. Some demos also utilize the basic logic flow and create the interaction on the interface level so that they appear to be alive. To create a demo, the interface design and the logic graphs are needed, also for any learning product; learning content is needed to show how the content is displayed on the interface.

Product Demo Creation. With the feature lists, basic interface design and logic flows, one may be able to beautify the interface design, and create believable interactive scenarios for others to try. The product demo consists of everything that a product may appear to have, without any actual coding. This is the mockup of the final product and provides the basis for discussions and suggested improvements. Generally, the product demo is for demonstration purposes to outside parties.

Demo Content Creation. As mentioned above, the product consists of a content part and a tool part. The content part, when creating a demo, needs real content to be put into the interface. The content creation process requires the content production team to create content demos according to the feature lists and learner specifications without going into the design phases.

Learner Experience Testing. With the demo, or even the interface design with some content, Learner Experience (LE) tests may be carried out to see how the learners experience the mockup product. There are many way to conduct LE tests, such as learner surveys, focus groups and interviews. However, for mobile learning products, the tests will not only assess how they use the product, but also how much is learned after using the product for a short period. The learning result testing is the inherent part of the LE testing for mobile learning products, and it is often carried out by short quizzes, follow-up interviews and reality task assessments. The result from the LE tests will be the key for the recursion of the process. If the LE tests give out many suggestions and advices, the basic design process will have to be carried out again. If not, the process transitions directly to the following one.

Learning Product Detailed Design. After the prototype of the product is approved by LE tests, detailed design of the product is next. The product has a content part and a tool part, therefore the design process has the corresponding sub-processes. Although Content Detailed Design and Tool Product Detailed Design may be regarded as separate mini-products, they belong to one larger product and are very closely connected with each other. Because they may be intrinsically different, the design processes for them are also different. After the two parts are designed carefully, the technical analysis of the designs provides information for the developers so that they may have a better view of the product from a technical development point of view.

Mobile learning product design is closely connected with content and resource design. Most of the design processes of the content product need to be synchronized with the processes of the content design, and the tool design is very dependent on the design of the resource that tool products utilize.

Content Product Detailed Design. The content part of the mobile learning product is usually the knowledge delivery part. Content in mobile learning product development refers to learning materials with certain arrangements in order for the learners to learn and reach a preset goal in a controlled pace of progression. Content may vary in style and format depending on the content subject, however, the presentation of the content, the interaction between the content and the learners and assessment are the crucial parts of the content product, affecting the learning experience and the learning results at the same time.

Learner Interface Design. The learner interface is the interface where learners interact with the content. They may read, memorize; browse and organize the content according to one's own preferences. The interface design gives the learners the ability to manipulate the content, such as choosing a course, browsing the chapters, choosing a lesson, doing exercises and other additional functions related to the course, such as mini-games and activities. The difference between the learner interface design and the learning content presentation design is that the learner interface design is related to the layout of the product, giving learners the ability to manipulate the content. However, the learning content presentation design relates to presentation of the content to the learners according to a content design that is the most readable and appropriate for the learners.

Learning Content Presentation Design. For any content product, the content presentation is very important. A classic mobile learning content product may contain text, image, audio, video and interactive learning materials. For text materials, there may be long paragraph materials, short paragraph materials, multilingual materials, materials with interactive properties and text materials assessment approach has to be standardized and controlled. However, other courses can be flexible and interesting because the assessment may only be a reference to the learners of their progress. The design approach is very dependent on the technology at hand and the assessment requirements from the course design.

Learning Logic Flow Design. The interface, content presentation, platform integration and assessment approach may be considered as the constructing elements of the content product. In addition the learning logic flow design connects the elements together with underlying workflows and user cases, creating the technical interpretation of the functions that are in the feature list of the product. The logic flow design may include flow charts, forms, descriptions, interactive demos, etc., to clearly explain the logic for the modules and functions.

Tool Product Detailed Design. Tool product is one part of the product, which is used as an instrument to help the learners to learn the content better, or to help the learners to practice the learned knowledge in real scenarios. For example, for a language course, tools may include dictionaries, translation services, complete conjugation tables, grammar libraries, etc. For mobile learning courses, these traditional learning tools will have to be modified to accommodate mobile learning features. Although the tools may seem to be traditional tools in new technology forms, the limitation and the capability of the new technology will also require simulation of the tool in the new technical environment as well as the usability optimization.

Learning Tool Interaction Simulation. The first step to design the tool product is to simulate the interaction between the learners and the traditional tools. The simulation includes user case setups, function mobilization and interface design. The goal of the simulation is to almost completely reproduce the interaction, result presentation and other aspects between the tool and the learners just like the traditional learning methods, but in a mobile learning theoretical framework.

Tool Logic Design. Just like the logic design for the content product, the logic design for the tool product is to clarify the technological logic lying within the interaction simulation.

Learning Usability Optimization. Because the tool product requires the learners to interact with it frequently, usability optimization is important. Interaction simulation with reference to traditional methods is the first step of designing the form of the tool and the way the interaction is executed, but mobile environment is still quite different from the traditional learning environment, therefore special steps of usability optimization are needed for the tool to be learner-friendly when used in a mobile situation. The optimization includes interface optimization, interaction optimization, resource optimization, result presentation optimization and mobile device optimization.

Technical Analysis. Following product design, with all the product design work finished, the design work is categorized from a technical development point of view. The technical analysis identifies the functions with different development priorities in terms of project management and groups the functions with the same priority level into future delivery packages for quicker design, development and test cycles. In addition, the functions need to be grouped into modules for modular development and a flexible product structure.

Development Phases Identification. The features listed together with the detailed design are classified into three general development phases. The first phase aims at the most basic and core functions, the second phase aims to add improvements to the core functions and construct links to the existing platform. The third phase aims to complete all the designed features.

Function Confirmation & Grouping. While the functions are given different priority levels, they are grouped into independent modules and systems to achieve a flexible product design. In this modular design, functions may be added to a module without affecting other modules and every module may be taken on and off freely without bringing the whole product down.

Learning Content Design 1010. The learning content is the content that is to be presented in the content product and learned by the learners. The main course content includes resource material that is used by many tool products. Content and resource is different. For example, content needs to be designed to fit a certain mobile pedagogy and constructs a full circle of learning activities from learning to reviewing and testing, but resource materials are dictionary entries, exercise answers, key knowledge points, etc. do not need to follow a certain pedagogy but accompany certain courses forming the content database for different learning-aid tools.

Course Design. For content product, the content itself is actually a course. To design a mobile learning course for learners, one has to first understand what the teaching methods are in a traditional teaching environment. Then, following the mobile learning course design process, five aspects of the course are carefully thought through and designed.

Course Progression Design. Course progression is the distribution of the lessons, exercises, activities and quizzes. The distribution may be according to time spent on the course from the learners, or the level of the learner. In addition, the distribution may be course-specific or lesson-specific. The course progression design helps to spread a certain number of knowledge points: reading materials, exercises, activities, tests, quizzes and other learning elements through a certain course timeframe to create a rhythmic learning pace, which bears characteristics of mobile learning such as context-aware, short, efficient and practical.

Goals & Assessment Design. For certain courses, the goal is very clear and utilitarian; therefore, the assessment will also have to be very scientific and effective. For other courses, the goal may be not as worldly, but certain types of assessment will also have to be designed into the course to serve as reminders to the learners to show how they are doing and what they have learned. Goal design is closely linked with content progression, and the assessment design is linked with delivery technology and learning environment.

Course Structure Design. Course structure design is to design the overall arrangement of lessons and topics throughout the course. Course structure design breaks down a course into several chapters or sub-courses and assigns topics to them to form independent sections. The course element design is at the course level, and the progression design is the course element design at the lesson level.

Courses Interconnection Design. One course may be able to form course combinations with other courses. The courses interconnection design looks at all the available courses at hand, and groups the relevant courses together to form large learning units for learners to choose. The combination may be based on topic, difficulty level or other external standards.

Micro-content Structure Design. Micro-content units construct the course, and the structure design of these small content units specifies the parameters that are required by course design to clearly identify the whereabouts of the micro-content units in the whole course as well as the information included in the metadata of each unit. The structure design is required by the product design so that the content may be easily identified and used by the platform and the logic flow.

Resource Design. Resource is a kind of learning material that is used by learning tool products. Unlike content that is used to form mobile learning courses, resource does not need progression design, assessment design and such. Resource design, however, needs to be closely related to the courses that it is supporting, as well as the technical form of the tool product so that the resource database structure matches the presentation in the user interface.

Resource Requirement Specification. Because the resource is relatively simple compared to the content, which forms the course, the requirement specification, is also easier. The resource requirement specification specifies the properties of the resource, such as subject, content, difficulty level, editing principles, length of each entry, etc.

Resource Database Structure Design. The database structure describes what parameters the resource may need from the original sources and how these parameters are stored in a database. The database structure specifies all the important parameters, connections and values of the parameters according to the multimodal presentation design from the product design process.

Resource Standards Design. For all the resource serving different purposes, the parameters and values as well as metadata need to be standardized in order to mass-produce the similar resource content. The standards may include metadata, basic datasheet structure, collection process and other information of the resource.

Learning Content Gathering 1012. After the structure, organization and presentation of the learning content are designed, the collection process will begin to start collecting content that fits the requirements from the design specifications. Generally this process will use a pool for the source of the content needed to be gathered and modified, and with help from a set of tools, the content editors may process the raw materials and change them into well-organized content, which fits mobile learning standards and theories.

Learning Course Collection. The learning course collection process corresponds to the course design process. This process gets information from the course design process, edits the materials from the content pool with tools to micro-size the materials, and make them into mobile learning lessons. Finally, the courses will need to setup connections at the content level so that a course may have available links to other courses.

Content Pool. The pool is the collection of sources where the content may come from. The pool may consist of books, Internet websites, premade databases and other learning-related sources.

Micro-sizing Tools. The transformation in the mobile learning content preparation where the normal learning materials get edited, modified and changed into small, ‘bite-sized’, interlinked, self-independent learning objects is called micro-sizing. The process requires the editors to make the materials, such as long paragraphs of texts, long, audio and video sessions and large images to be micro, therefore the tools for the process are needed. For example, if the materials are text, cutting, organizing and summarizing tools are provided to make the content more compact according to the distribution of the knowledge points in the original content as well as the design of them in the prepared materials. Also, after splitting and reforming the content, titles and endings need to be added to the content body to create hooks to following content, activities and assessments so that an inner logic structure of course progression can be produced to provide a coherent flow of knowledge and learning experience.

Course Planner. Course planner manipulates the micro content and puts it into the course structure that is designed in the previous process. The planner utilizes a visual dragging tool to create markers of the micro content as building blocks and drag them into a tree-shape or a linear course progression structure according to the design. The planner gives the editors a good way to visualize the whole course structure.

Content Editing Platform. The platform gives the editors a workspace to operate the micro-sizing tools, and serves as an importing gateway. The editors may be able to process and modify the content on the platform using the tools, and when the content is ready, the editors are able to import the prepared content into the course databases, or to export the existing content from the database to do modifications, so that the continuous supply and update of content may be possible.

Standard Difficulty Assessment. The assessment is for assessing if the content processed reaches a certain level of difficulty. The assessment uses a set of standard difficulty assessment values to set the baseline of the desired difficulty level. Through comparison of the content with the values such as vocabulary, knowledge points, repetition rate, etc., the assessment process may determine if the content has reached the designed difficulty level or exceeds the difficulty level. This process is to assure that the content fits the needs of the learner group.

Resource Collection. The resource collection process is to process and modify resource materials from resource pools gathered from elsewhere or created by one, and following the resource design, make the materials usable for the tool product part of the new mobile learning product. Resource collection is simpler than the course collection, absent of structure arrangements and connection building.

Resource Pool. The pool is the collection of sources where the resource materials may come from. The pool may consist of books, Internet websites, premade databases and other learning-related sources.

Resource Editing Platform. The editing platform provides the editors the abilities to create resource tables, which fit the resource standards designed in the previous process. After the tables are created, the editors may be able to modify the resource materials into smaller units, which eventually become the entries for the resource tables following the instructions given by the resource requirement. The platform also provides the importing tool so that after the editing, the editors are able to directly import or export the materials to the database or out of the database for updates and modifications.

Learners' Feedback 1016. After the product is released to the market and used by the learners, it is important to gather information about their using and learning experiences and observe their learning scenarios for improving the mobile learning product. This information comes from the learners and it may come from two different ways: passive collecting and active session analysis. The passive collecting is through mechanisms and data collecting modules, which are embedded, into the product as part of the learner management system. This data collection requires learners to be actively using the product, thus called active learner data collection. The other way to collect learner data is to interact with the learners through telephone interviews, conferences, questionnaire investigations, etc. This set of gathered data completes the analysis of learners' behavior and feedback so that it can be used for product upgrade and new product initiation.

Active Learner Data Collecting. The active learner data, such as learning progression status, learning tool interaction data, learning preferences data, etc., is collected during the interaction between the learners and the product. The collector will collect all the data specified by the configuration module, and send it to the analyzer to generate meaningful reports about the learners.

Active Learner Data Collector. This sub-process collects the data specified by the configuration module. The collector uses the intrinsic mechanisms embedded in the products, and from the interaction between the product and the server or the learning platform, a certain amount of data is transported back to the platform and is gathered by the collector. Products may need to keep a profile of the learners, and the profile data can be used as the data source for the data collector.

Active Learner Data Configuration. The configuration module gives different products different parameters and key points to follow and monitor. These data may include learning progression status, pacing speed, difficulty monitor, learning space and time values, topic preferences, learners region differences, subscription ratio, etc.

Learner Data Analyzer. The analyzer gets information from the data collector, and with the configuration settings, the analyzer processes all the information and generates reports, which cover all the important operating aspects of one product. The results from the analyzer will guide the product upgrade and future product initiation.

Learner Behavior Interactive Analysis. The interactive analysis may be used when some aspects of the learner may not be observed through data, or reasons underlying certain phenomena need to be uncovered from only the learners. In these situations, the way of interaction between the product and the learners must be through face-to-face interview, telephone interview, questionnaire, conference, etc. For such activities, the process or the flow of the activities must be designed first, and the materials, such as questionnaire used in the flow, must be designed to achieve the best results.

Learner Feedback Collection Design. The feedback collection design focuses on the design of the feedback collection process, for example, if a collection process should be carried out through telephone interviews, the goal of the interview, the number of learners needed, the selecting criteria of the learners, the process of interaction with the learners, etc.

Learner Questionnaire Design. The questionnaire may refer to the list of questions used during an interview or a questionnaire answering session. The questionnaire needs to be designed before the targeted session to get the most information related to the purpose of the interviews out of the learners.

Mobile Learning Research. Mobile learning research is a crucial part of the whole product process, Mobile learning is a new and developing field, and many areas of the field are still in development and incomplete. As more products are produced and released onto the platform, more questions regarding mobile learning theories, learners, product design and other hot issues may be raised. To answer them will be crucial for the next generation of learning product development. There are five sub-processes within the research process. Many researches require experiments, so the design process of the experiments is very important. Learning objects standards research helps to set, up standards for content and resource to speed up the process of generating new learning materials. Mobile pedagogy affects the content design and the product design, and new pedagogy may lead to new types of products. The integration of learning and gaming is widely debated in the industry, and with mobile technologies added, the learning gaming may be more varied and interesting. The educational technology research looks at combining current education with new technology with a goal to create new and better learning products.

All of the research areas may greatly affect the current education models and bring innovative ideas to the design of learning products. They are the driving force of product and idea innovation.

Learning Experiments Design. The learning experiments are used to test ideas that are formed from interaction with the learners, new technologies and new products appeared in the market. The experiments are designed much like the feedback collection design with specific target group, goal, experiment procedures and control group.

Learning Objects Standards Research. Learning objects are units of knowledge that are used by learners. They can be a paragraph of text, a video clip, a sound clip or other type of integrated information units. The standard of the units may affect how these units are made from raw traditional learning materials, how they are stored in the database, how they are combined into larger lessons or courses and how they are transformed from the requirement of one type of mobile technology to another.

Mobile Pedagogy Research. Mobile pedagogy is the teaching method that is used for course production, learning activity design and assessment design. Therefore, the advancement of the mobile pedagogy directly affects the design of the mobile learning products, as well as the efficiency the learners acquire knowledge from the mobile learning products.

Learning Gaming Research. Gaming has been the new frontier for education research, and combining learning with mobile gaming is the very latest innovation. Learning gaming research is actually part of the information delivery mechanism research, which renovates the means of information delivery from the source, i.e. the product, to the target learners. Mobile learning gaming research may affect the product design, as well as the behavior of learners.

Educational Technology Research. Educational technology research looks at how the traditional learning materials, course organizations, learning roles and interactions can be replicated with technological methods onto a virtual learning platform. The focused technology is mobile technology such as GPS and RFID. The application of such technologies may give education new possibilities and affect learning behaviors as well.

In summary, Muuzii mobile learning product development process focuses on mobile learning products, especially products for primary and secondary school students, which are a Muuzii innovation. At Muuzii, we transform mobile learning with easy-to-understand and fun learning. The active learner research and data collection, cyclic design processes and multiple concept re-examination procedures form a close circle of the Muuzii Product Development Process. The Muuzii Product Development Process plays a central role in the innovation of education and learning. It powers the engine of mobile learning to provide cutting-edge design and first-class learner experience that can only be experienced with the “Muuzii Way.”

Mobile Learning Content Management. Content Management System manages Muuzii services and products and includes three key modules involved:

Service Content Synchronization Module: It is responsible for content synchronization between service system and content system.

Service Content Management Module: It is responsible for adding, deleting, modifying, checking and editing services and products' content.

Service Content Import/Export Module: It is responsible for content import/export operation, including format conversion and content adaptation.

Mobile Learning Services and Products. Based on powerful mobile learning system process and mobile learning product development process, Muuzii has successfully created various applications with all or some parts of the processes enabled. To follow such a high-level technical framework, mobile learning services provided by Muuzii are governed by standardized rules, principles and conventions, as well as powered by experiences Muuzii has in the field of mobile learning.

MLS not only gives a framework upon which endless mobile learning services can be easily designed and created, but it also forms the technical foundation of modern mobile learning theories. Thus, MLS pushes the qualities of mobile learning services to a new level. MLS is the heart of all novel and interesting mobile learning products and it enjoys an end user base of one million subscribers.

All of the mobile learning services Muuzii provide share common features, because they all follow strict mobile learning theories that Muuzii has been creating and enhancing, in order to achieve the goal that is to provide the users the most useful learning materials in the most comfortable way.

Easy to Use: All of the services have been following the minimalist way of designing. Muuzii believes that good services are all simple by look but in fact, there are layers and layers of background study and ideas behind the simple appearance. In this way, users will not be intimidated by the complexity of logic at first, but still enjoy a sophisticated experience that mobile learning services can provide to them.

Nice to Study: Muuzii is very good at fusing study and fun. In terms of content organization, following the general principles of language study, Muuzii studies all the language skills and seeks interesting ways to exhibit them in a memory-friendly way. What Muuzii would like users to experience is to learn while being interested in what is happening around them, to learn with the least memory burden and to learn using little fragments of time with a whole complete structure of progression.

Simple to Control Muuzii advocates freedom of learning, which means at the same time the freedom of place and time, and the freedom of knowledge and progress. Every Muuzii service provides tools for users to customize the content they would like to receive, the speed they would like to proceed at, the mobile channels they would like to use and the progress they would like to follow. Within a complete system of skills and goals, users can enjoy the greatest freedom they can ever get to create the learning services of their own, and the stimulation from such customization is one of the keys for users to understand and continue using the services and learn from them.

Little to Ask: not limited by space, time and technical devices, Muuzii creates mobile learning services that ask for little from the users. Muuzii has been researching all the mobile channels and content delivery methods with education and learning in mind so that people can all worry the least and enjoy the most.

For Muuzii mobile learning products, three categories are obvious:

Teaching services which serve the purpose of teaching or informing people of what should be learned and how they should be taught;

Tool services which serve the purpose of giving users greater convenience when learning; and

Edutainment services which provide interesting and stimulating ways for users to learn and be entertained at the same time.

In addition, a mobile learning portal is needed for users to check out various aspects of their mobile learning status.

Teaching Services. Teaching services provided by Muuzii always follow two principles: easy to use and fun. Of all the contents that are created and presented, easy to read, easy to digest and easy to remember always are the keys. Reading without much of gives users pleasure, confidence, and knowledge even if they do not realize that they are actually acquiring content they need to remember. Fun is another key to mobile learning. Due to mobile learners' distraction and shortage of time, fun content helps to maintain the attention of the users and leaves a deeper impression on a users' memory.

Teaching services are usually multimodal. Every kind of teaching se ices involves at least two of text, audio, pictures and video, and almost the entire teaching services use more than one mobile channel to deliver learning content to users. Different types of content organization and presentation are also used for better performance and overall novelty.

For teaching services, despite their easy and fun appearances, mobile learning education theories and content organization principles are in place for the high quality of teaching and learning. Muuzii has been researching mobile content delivery and mobile learning efficiency, and provides complete structures of full courses for users to achieve the best results.

Tool Services. Muuzii provides a series of tool services to users. Based on different kinds of courses, tool services also vary. From the most accurate Chinese-English translation to dictionaries, from micro blogging to group seminars, Muuzii looks for the most effective instruments for mobile users to use, participate and smooth the process of learning.

Most of the tool services are also multimodal and multi-channel. The wide range of accessibility helps mobile users to use all the learning instruments provided with ease, and makes it fun to use tool services to learn. Tool services party with the most relevant teaching services to form courses so that every mobile learner can get the best experience they can ever get on the mobile platform for learning and education.

Edutainment Services. The fun element is expressed to the extreme in edutainment services. Although games, quizzes, comics and other expressions of edutainment are created in the strictest sense of mobile learning products, they appear to be completely unconventional when comparing to teaching and tool services. Aiming at providing learning experiences through entertaining ways, edutainment services focus on delivering learning content in subtle ways so that users develop the target skills or learn the target lessons without realizing or making much effort.

Edutainment services are another viable way to education, and they form part of the full mobile learning product lines.

Muuzii computer-assisted mobile translation platform. The automatic machine translation systems available today are not able to produce high-quality translations unaided: their output must be edited by a human to correct errors and improve the quality of translation. Computer-assisted translation (CAT) incorporates that manual editing stage into the software, making translation an interactive process between human and computer.

Muuzii computer-assisted translation solutions include controlled machine translation (MT). Muuzii MT modules allow for a more complex set of tools available to the translator, including terminology management features and various other linguistic tools and utilities. Carefully customized user dictionaries based on correct terminology significantly improve the accuracy of MT, and as a result, can increase the efficiency of the entire translation process.

Range of Tools

Muuzii computer-assisted mobile translation platform covers a set of tools that involves translation process, including: Spell checker, Grammar checkers, Terminology managers, Bilingual dictionaries, Terminology databases, Full-text search tools, Linguist managers, Project management system, Translation memory tools, Application servers.

To optimize the source content, translation process, Muuzii have developed a whole workflow and some core application servers.

Translation Trigger Engine Server. The Muuzii Translation Trigger Engine adopts a dynamic load-balancing configuration for maximum translation efficiency.

Machine Translation Engine. The machine translation engine utilizes the world's most advanced bilingual engine (such as Chinese-English) providing the most accurate machine translation. It can auto recognize the original language and translate into the target language.

Muuzii Pre-processor. The pre-processor gives the Muuzii translation engine attempts to correct user input errors. Based on Mobile Internet morphological characteristics research, Muuzii translation technology recognizes a large number of linguistic irregularities, such as lexical errors, misspellings, syntactical errors and synonyms, and modifies them to conform to the language's standard grammar and guarantee accuracy and fluency.

Muuzii Post Verification System. The post verification system is a linguist checking system, after machine translation engine's auto translation, the result will be delivered to linguist platform in queuing and then it will be assigned to an available linguist. After the linguist revisions, the result will be pushed back to the SMS/MMS gateway to deliver to the subscriber.

Linguist Workstation Server. This is a human-machine interactive platform, provides translation verification working environment and a set of tools for linguists to speed up the verification, improve the verification accuracy and form high efficiency human-machine interactive processing procedure.

Real-time Translation System. Real-time Translation System is responsible for Muuzii translation engine calling and machine translation accuracy evaluation, there are four (4) modules involved in the transactions:

Real-time Translation Engine Module: Calls machine translation engine to translate source language text to target language text in real-time.

Language Package Configuration Module: Configures specific language package for machine translation engine calling, such as Chinese-English pair.

Language Package Calling Module: According to configured information, it dynamically calls various translation language packages.

Translation Result Evaluation Module: Evaluates the accuracy of each translation result to make sure it is a serviceable translation.

Auto Translation Distribution System. Auto Translation Distribution System will auto distribute the machine translation result to the corresponding linguist for verification purpose:

Smart Distribution Algorithm Module: According to translation request type, it intelligently distributes the request to a different linguist.

Seat Status Synchronization Module: Manages the linguist seats, such as linguist eat status (busy or idle), linguist-working load, etc.

Service Request Push Module: It will push the linguist verified translation result back to the communication platform and send back to the subscriber's handset via operators' gateways.

Main Features. The Muuzii Mobile Translation Optimization Process gets the following features:

High Accuracy. Muuzii translation process could achieve 95% translation accuracy even for voice translation, and it makes up for simple machine translation's largest weakness.

High Speed. Pure human translation speed is about 10 Chinese words per minute, while Muuzii could achieve around 50 Chinese words per minute. It meets the user's demands for rapid translation and gets a wide range of application scenarios.

Powerful Intelligent Database. Muuzii constructs a powerful adaptive/self-learning Intelligent Database by automatically adding various types of corpora, which is selected by Muuzii processes by constantly improving the translation accuracy and speed. It automatically converts artificial intelligence to computer intelligence, improving translation system processing capability, reducing the requirements for human intervention and linguist cost.

The longer the platform runs, the larger scale of the platform, and the more corpora it accumulates, the faster translation speed and the higher accuracy it will get.

Unique Human-machine Interactive Workstation Design. Muuzii Mobile Translation Optimization Process is a multiple mechanisms collaborative design, guaranteeing the high speed of human intervention and high accuracy of the translation result.

High Language Tolerance. It is with high tolerance for dialect, accent, voice speed, non-standard word order, network buzzwords, and Chinese-English mixed input, ensuring the translation accuracy.

Strong System Compatibility. For different language pair translation, it is able to call voice recognition engine and machine translation engine with the highest accuracy, to achieve the optimized machine processing results.

High Reliability and Scalability of the Platform. It is with the capability of supporting all operator's customers and mobile Internet customers to use accurate voice and text translation services.

Support Multi-channel Access. Including SMS, MMS, WAP and Mobile Web.

Personalized Service. Meet the customers' individual needs under different scenarios such as high priority for speed or for quality.

The Muuzii Mobile Translation Optimization Process is a unique process that represents the Muuzii proprietary concept of incorporating a translation process with highly accurate results in a mobile environment. The Muuzii process focuses on improving any typical translation engine through dynamically optimizing the pre-translation materials through a series of modules, systems and configurations, and adapting content identification, management and distribution within the process. The result of the said process is that the translation requests generated by users in mobile environments with wireless connection can be processed very fast and with very high accuracy at the same time.

The translation processes are divided into two types, one is text translation, and the other is voice translation. We believe that text translation is the core of the translation process, and generally speaking, voice translation is a process of adding voice recognition and voice synthesis based on text translation.

For text translation, fully automated machine translation accuracy is just about 70%, to be commercially viable service, a manual intervention is needed to improve translation accuracy. For the first time, Muuzii pioneered and engineered a process of machine translation combining with human-machine verification process to improve the translation accuracy to approximately 95%, while the translation speed is about 5 times faster than human translation. Similarly, for voice translation, the translation accuracy depends on the base accuracy of voice recognition and text translation. Therefore, human-machine verification is a very important step adopted for voice recognition. After utilizing verification process for voice recognition and text translation, the accuracy will also be able to achieve approximately 95%.

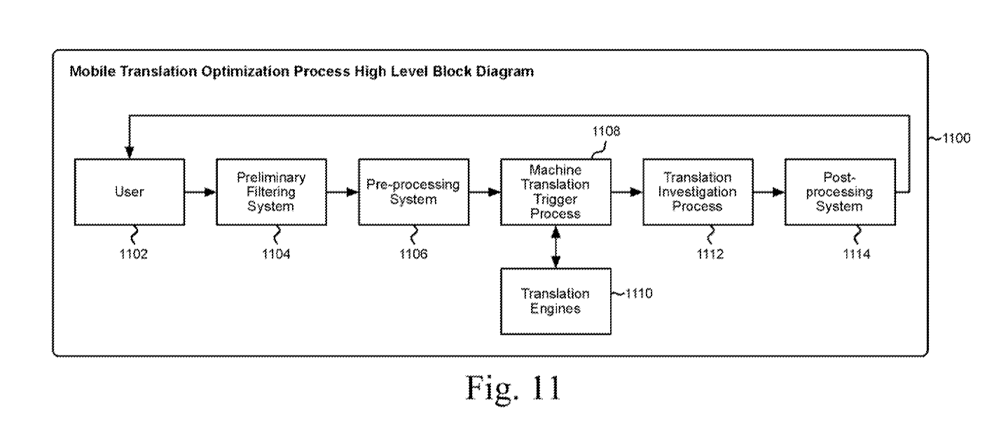

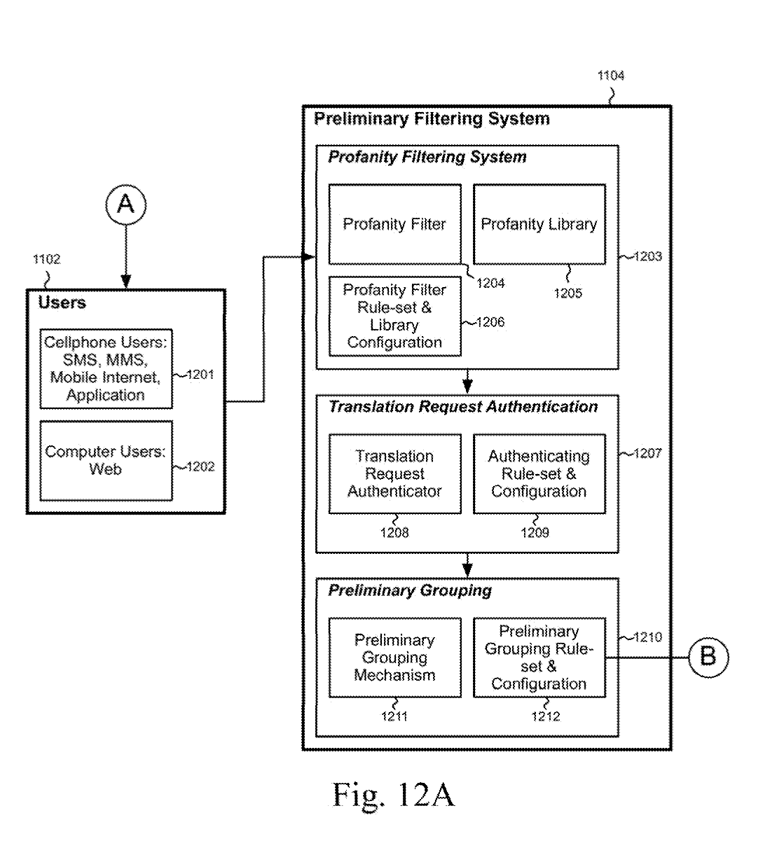

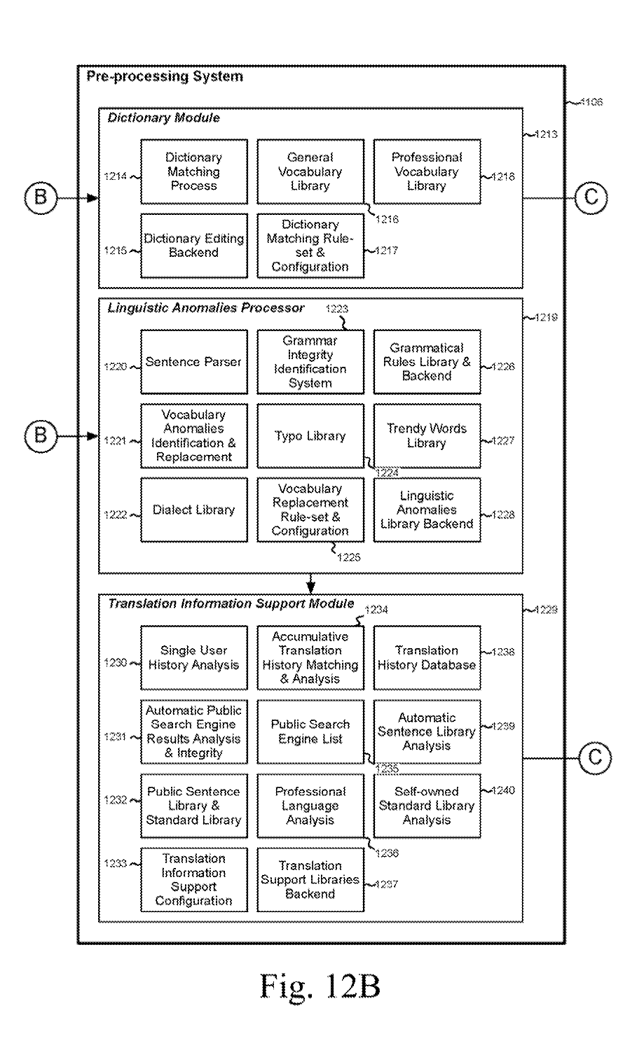

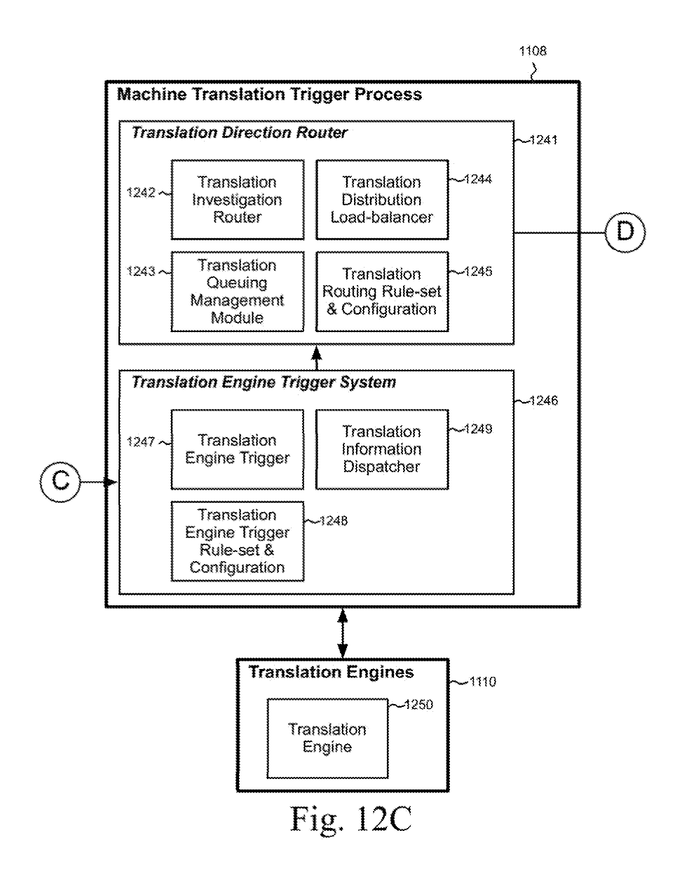

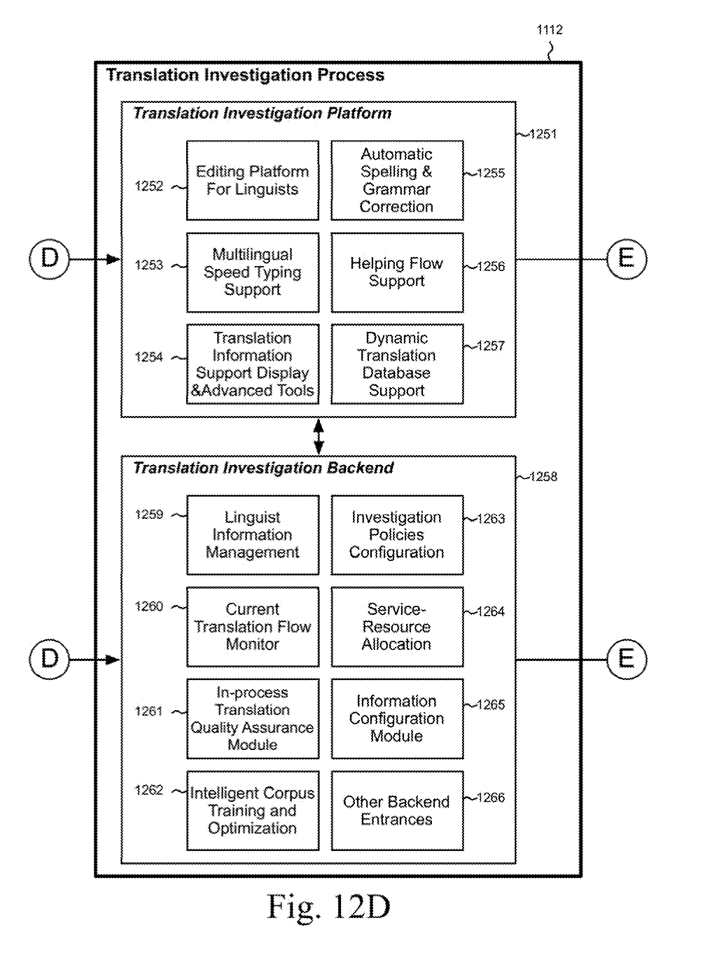

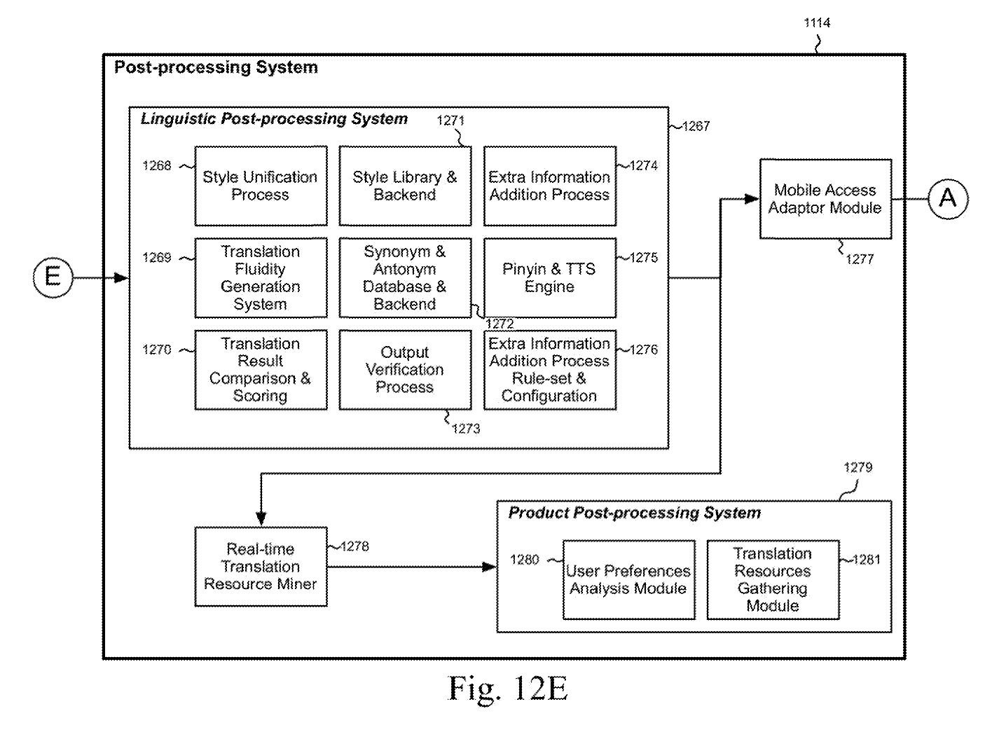

The Muuzii Mobile Translation Optimization Process 1100 combined five unique sub-processing methodologies, which are: Preliminary Filtering System 1104 scheme, Pre-processing System 1106 scheme, Machine Translation Trigger Process 1108 scheme, Translation Investigation System 1112 scheme and Post-processing System 1114 scheme as shown in FIG. 11. Each of the subschemas is more thoroughly described in the following section with a full block diagram as shown in FIGS. 12A to 12E.

Turning now to FIG. 11, Muuzii Mobile Translation Optimization Process Platform (MTOP) Block Diagram 1100 displays major subsystems, engines and functions of each subsystem with their relations shown in the entire process flow. This block diagram presents Muuzii's innovative process idea of how functions and systems are organized, interconnected and categorized, and how the workflow is going through the entire system. Each of the blocks of the sub systems will be described and, explained below according to the full version of the diagram.

In this section, each of the processes within the Muuzii Mobile Translation Optimization Process 1100 will be described in detail including functions, flows and business relations. As a process, when more experiences and real scenarios are gathered from the operation, the process will be updated constantly and new features will be added to the process flow to optimize the process. Therefore, the process will be likely to change and evolve over time.

Turning now to FIG. 12A, Users 1102 of Muuzii Mobile Translation Optimization Process 1100 are people with mobile access and in need of translation. The platform itself provides all the possible access channels for users to choose, from the simplest SMS to mobile Internet and smartphone applications 1201 and 1202. Different mobile technical channels such as SMS, MMS, etc., may bear different characteristics and be fit for use in different situations, but users' language may not vary that much among the channels. Therefore, it is crucial for users of all mobile technical channels to have access to the platform so that the flexibility and convenience of the mobile channels may be fully embraced by the platform and the process itself.

The users initiate the process and will be the terminal for the process. It is very important to always have Users 1102 in mind, especially how users experience the process as a whole, coherent and dynamic entity when they are accessing it through different mobile technical channels.

The very first of the process is Preliminary Filtering System 1104. For translation engines, purity and normality of the translation requests from users are very important for correct results. In a mobile environment, often, the translation requests are heavily polluted with words and phrases, which should not be processed by the platform at all, such as profane words, mistakenly sent messages, service subscription commands, signatures, messages with no letters or with gibberish, etc. This system serves as the gatekeeper of the whole process and mainly contains modules that try to deal with the not-for-translation part of the incoming materials before the real translation process starts. The modules work on the raw messages, and filter out the profane, the mistaken and other anomalies. After the filtering, the platform will need to split all the requests into vocabulary requests and sentence requests so that different processing measures can be taken to guarantee high efficiency and accuracy. Therefore, the preliminary grouping will occur following the filtering process and group the incoming translation requests into vocabulary requests and sentence requests.

The Profanity Filtering System 1203 is the first line of defense to the chaotic and creative use of language in mobile environments. This system helps to filter out profane, sensitive and other indecent words, phrases and sentences within the translation requests. The system can also support different filtering policies for translation requests with different features, such as source, time, length, etc. This system is backed up by the Profanity Library 1205 and provides a backend for linguists to edit to make corrections, or to add correlations and words.

The Profanity Filter 1204 is the core module of the Profanity Filtering System 1203. It scans all the translation requests that go through and search for anything that matches the entries in the library. The rule-set provides the filter necessary information for what it should do to individual services and applies different matching mechanisms to translation requests from different services. When it finds profanity, it will extract the translation request out of the translation flow, stop it from going any further and send out warning messages to users.

The Profanity Library 1205 is for the filter to use. For different services, or to be specific, for different regions, language pairs, user groups and carrier restrictions, the library will be different. For all the profanity entries, specification of the use of the word is very important so that the filter will always use the most suitable library in order to filter all the unacceptable messages without overreacting to things that are all right to the particular groups of users.

The Profanity Filter Rule-set & Library Configuration 1206, just like the library, this filter also takes on rule-sets for all services. These rules give the filter information about the filtering level, matching library and warning messages for specific services. The configuration function gives linguists the ability to change the information when services change, as well as provides linguists an editing tool for editing the profanity libraries. For example, if one service requires filtering level changes because it now expands its user group to younger people, linguists may change the rules for the filter accordingly.

Besides the profanity words and phrases, the other category of translation request pollution lies in messages that contain unintelligible or mistakenly sent information. Translation Request Authentication 1207 blocks and processes all the incoming requests that are not intended for translation. Those mistaken messages can be commands for other services or procedures, messages in corrupted codes, messages that only contain one single letter or one space, mistakenly sent messages, signatures, messages with no letters or with gibberish, etc. They are generally considered to be lowering the total efficiency of the process, so this process deals with them and takes them out before translation procedures start.

Translation Request Authenticator 1208, together with configurations of specific services, will execute authenticating process and block the messages, which are defined to be not intended for translation. The process will also generate responses to users for clarification of their messages not being translated.

Authenticating Rule-set & Configuration 1209 takes on rule-sets for all services from here. These rules give the authenticator information about the blocking level, blocking rules and warning messages for specific services. The configuration function gives linguists the ability to change the information when services change, and change the rules in the rule-set when necessary.

After the initial cleaning, the translation requests are now comparatively tidy. In consideration of translation efficiency, for words and sentences, different processes should be utilized for better and quicker result generation. It is then necessary to categorize the requests into these two categories so that the platform reacts to them differently. The Preliminary Grouping 1210 process helps to identify whether the incoming requests are vocabularies or sentences and through this grouping helps the Pre-processing System to determine which request goes into what subsystems and modules.

Preliminary Grouping Mechanism 1211 happens here when the mechanism follows rules defined in the rule-set and distinguishes words from sentences, if the grouping is allowed for these services as certain services may not need grouping at all. When distinguishing is done, the mechanism will transfer the identified translation requests with different markers to the next module, Pre-processing System, for other processes.

Preliminary Grouping Rule-set & Configuration 1212 takes on rule-sets for each individual service from here. These rules give the preliminary grouping detailed instructions about the grouping rules for these services. The configuration function gives linguists the ability to change the configuration when services change, and change the rules in the rule-set when necessary.

Turning now to FIG. 12B, The Pre-processing System 1106 is a very important part in the whole process of translation. The Preliminary Filtering System 1104 gets rid of the things that are not for translation, the Pre-processing System 1106 also deals with pollution of the language in mobile environments but it focuses on the linguistic irregularities that are commonly used in mobile conversations but cannot be understood by translation engines. Translation engines tend to process better when the input conforms to linguistic norms. Therefore, before the translation requests go into the machine translation engine, they need to be tithed up and fixed according to dictionaries, recognized grammar rules and other linguistic principles. For sentences, the Pre-processing System 1106 starts the sentence process, regulates common linguistic anomalies and irregularities, and provides detailed analyses to the sentence in question to support the following processes. Pre-processing System 1106 also processes all the vocabulary requests so that the vocabulary requests can quickly go through the following processes without going into the Machine Translation Trigger Process 1108, which sentence requests will have to go into.

Dictionary Module 1213 is the core of the vocabulary process. It takes in all the vocabulary requests grouped by Preliminary Grouping Mechanism 1211, provides accurate dictionary explanations to words, and phrases so that most of the vocabulary requests will not go through the translation investigation process.

Dictionary Matching Process 1214 together with the General Vocabulary Library 1216 and Professional Vocabulary Library 1218, helps to identify and match the words through language direction detection, priority check, context analysis and full text search, and then using the libraries to give either definition or information. For vocabulary, professional definition comes before the general definition according to the configurations of the matching process of specific services. Because there are a number of professional fields, this processor also supports multiple dictionary checking and automatic definition generation when a word or phrase is found in multiple dictionaries.

General Vocabulary Library 1216 contains words and phrases that are most commonly used. The library supports multiple language directions.

Professional Vocabulary Library 1218 contains words and phrases that are used in professional fields, The library supports multiple language directions (or translation directions) and multiple professions.

The dictionary libraries require continuous and timely updates. The Dictionary Editing Backend 1215 provides linguists necessary tools, such as search, edit, user administration and other functions. Linguists may use the backend to modify the libraries to fit the needs from the services and users. When anything unusual and related to vocabulary is discovered in the process, such as a new trendy word appears in the language flow, linguists can pick it up and use the backend to put it into the corresponding library.

Dictionary Matching Rule-set & Configuration 12.17. For every service, the dictionaries it uses and the rules far using the dictionary libraries may be different. The rules for the relationship between the general and professional dictionaries may be different, and how the definitions are combined together to make new ones may be different. Therefore, rules, configuration and the ability to change them are very important for the dictionary process as it directly affects the quality of the outcome of the process. For example, one service may require the general dictionary as well as the chemical dictionary, but the other service may only require the general dictionary. Different dictionaries working together may yield different and unwanted results therefore, the specific combination of dictionaries for any service must be configured and tested.

Linguistic anomalies, in other words, typos, acronyms, newly coined words and other linguistic phenomena normal machine translation engines struggle with are commonly found in the language people use in mobile environments. The Linguistic Anomalies Processor 1219 is a subsystem as well as a process where identification and correction of linguistic anomalies take place. The anomalies include typos, shortened words, trendy words, dialectic words, grammatical errors, etc. Cleaning these anomalies out of the requests will result in a quicker and more accurate translation process. This processor is the first of the series of processes, modules and subsystems in the sentence process.

Before any information gathering procedures, the sentences need to be parsed so that the sentence structures, phrases and word combinations are clearly presented to the translation processes. In addition, the statistical and analytical modules of the process will also need parsed sentences and the information the parser get from the sentences to do further work. The Sentence Parser 1220 parses the sentences and prepares the sentences with parsing marks for the following processes.

Grammar Integrity Identification System 1223 helps to determine if the incoming requests are grammatically complete or not. With the parsing information and the grammar rules, the system matches the sentence pattern and structure with the data and gives information about the grammatical completion of the sentence. Upon the detection of incompletion, the system will provide correction suggestions, correct patterns and other necessary information for the following processes. This system focuses on grammar only, because a grammatically complete sentence will have less ambiguity for translation engines.

The grammatical rules used by the integrity identification system are stored in the grammatical rules library. The library contains sentence patterns, phrase structures and other grammatical categories of the supported languages. The Grammatical Rules Library & Backend 1226 is used for altering and updating these grammatical rules.

Apart from grammar check, vocabulary anomaly check is also included in the process. The identification and replacement process will analyze the incoming requests and identify any linguistic anomaly, mainly vocabulary irregularities, found in the sentences, and replace them with the predefined entries in the libraries within the processor. Word irregularities are now very common as many words are coined every day on the Internet and in other new media and are embraced by the younger generations. It is very important to have Vocabulary Anomalies Identification & Replacement 1221 and update it so the translation requests can be edited into something the machine translation engines understand.

Typo Library 1224 contains misspelled words. For different languages, typing methods are different, and typos are saved separately in different libraries. Trendy Words Library 1227 contains newly coined words and words that are yet to be included by authoritative dictionaries. Dialect Library 1222 is a library of all words and phrases that are regional or dialectical, including dialectical words, specific place and food names etc. These libraries are used by the identification and replacement process.

For different services, vocabulary replacement rules are different. The configuration of the Vocabulary Replacement Rule-set & Configuration 1225 process manages the allocation of different libraries to different services. Linguists may freely change the configurations of the replacement process for the optimization of the whole platform.

All the libraries can be modified and updated here in Linguistic Anomalies Library Backend 1228.

For translation requests to be translated by the engines and investigated by linguists efficiently, it is crucial to have some background information about what the request is about and if there is any information about request has been created in various sources and databases that may help the engines and linguists. The information about the requests may be gathered through search engines, database search tools, and other analyses methods and is very important to translation engines and the investigation process that followed. With the translation requests, the Translation Information Support Module 1229 searches and analyzes using all the available resource and forms results to be sent translation engines and investigation modules.

What a single user has translated before generally shows a clear picture of the user's preference, field of interest and how they evolve. The Single User History Analysis 1230 module analyzes the sender of the incoming request through his own translation history, and tries to find information about the request, such as similar requests in the past, the near-message context, the environment indicators and language use habits. This information is very important to investigation process especially.

Instead of searching in the historical records of one user, this module analyzes the request and compares it with historical requests and results from other users for better understanding. In the horizontal comparison and analysis of the request, the Accumulative Translation History Matching & Analysis 1234 module determines if there is any similar request sent from other users in the past. This also gives references to the nature of the request and how the request should be handled.

For the vertical and horizontal analysis of the translation requests, the database these processes use is the same, which is the Translation History Database 1238. Every pair of translation request and translation result, together with the sender. time, service name, and other relevant information is recorded in the database. After a period of accumulation, for a specific service, the database will be very useful in cooperation with other modules and provide very useful information because for a specific group of users, the language use and vocabulary are quite regular and the pattern may be eminent after a period of observation and processing.

Using the parsing information for the sentence parser, the Automatic Public Search Engine Results Analysis & Integrity 1231 module uses several search engines to search on the Internet, and also search several times with different search principles and methods to gain as much information as possible to form the basic information pool for analysis for the translation request, and this is done when each translation request goes through the pre-processing system. Then, the search results will be analyzed and integrated into one report, showing the summarized parsing results and multi-principle search results.

The Public Search Engine List 1235 contains all the public search engines the module may be able to use, such as URLs and other interfaces of Google, Baidu, Sogou, etc.

There are many huge bilingual sentence libraries, or bilingual corpuses, available for searching. Generally, the bilingual corpuses contain large amount of perfectly aligned bilingual sentences from novels, newspapers or other sources. They may be great resources readily available for translation information gathering and accuracy improvement. With major sentence libraries and fuzzy matching, the Automatic Sentence Libraries Analysis 1239 module, with parsing information from the parser, may be able to process and analyze the results from the major corpuses, either extracting information or giving matching results from them.

The public bilingual sentence libraries are stored and integrated here to form a big source of information for the modules to use. New sentence libraries may be also added into the big library itself for updates. The Standard Library is created from the analyses of most frequently appeared sentences and sentences, which are difficult to translate because of many reasons. These sentences, when recurring level is above the set level, may be processed by the linguists again and put into the Public Sentence Library & Standard Library 1232 for other modules to use.

The Professional Language Analysis 1236 process is for deciding which profession the translation request may be coming from, or what classification criteria it may match. For a sentence, the sentence vocabulary, public search results and its pattern may bear marks of a specific classification. The main classification is profession, as profession may affect the language of the sentence greatly. Other classifications, such as mood, style, etc., are also important for investigation process.

The Self-owned Standard Library Analysis 1240 process provides the translation requests with standardized and verified information, which comes from the standard library. It either uses the standard library to bring out meaningful analysis results, or provides successful standardized matches to the requests.

For different services, translation support information is required differently in terms of detail level and source. The Translation Information Support Configuration 1233 process manages the allocation of different information gathering modules and processes to them. Linguists may freely change the configurations of the process for the optimization of the whole platform. For each information gathering modules and sub processes, the configurations may also be changed for more specific and targeted information.

All the libraries contained in the support module can be modified and updated here in Translation Support Libraries Backend 1237.

Turning now to FIG. 12C, after all the correction and analyses are completed, the translation engines are triggered and raw machine translation results are received from the engines for later processes to use. Therefore, the Machine Translation Trigger Process 1108 triggers translation engines, processes the requests in the engines and for the second time routes the translation requests according to routing policies. The translation results are matched with the translation requests, and because the translation requests come with the information from pre-processing system, the router will route the results and the requests according to the properties and send them to different investigation processes.

The Translation Engine Trigger System 1246 helps to trigger the translation engines with the translation requests for automatic machine translation. It sends the filtered and corrected translation requests to the engines for translation. In addition, it sends predetermined information gathered in the translation support process, pre-processing system to the translation engines so that more detailed and targeted translation results will be generated.

The Translation Engine Trigger 1247 sends the translation requests to the translation engines. The translation results are sent back by the translation engines to the trigger process and it accepts the results and forwards them to other processes.

The Translation Information Dispatcher 1249 receives information from the pre-processor. Because the information from the pre-processor is not formatted to be sent to the translation engines, the dispatcher re-packages the information and converts it into the format that translation engines can read, and then sends it to the translation engines. In addition, the dispatcher chooses the information that can be sent to the translation engines. For the information from previous processes that the dispatcher does not use, it sends them directly to the following modules.

The service, the engine and the information that should be dispatched to the engines should match. The Translation Engine Trigger Rule-set & Configuration 1248 module provides the ability to edit the translation engine related parameters, and linguists are able to change them when necessary.

The translation requests always bear values of different variables, and if the investigation process is done with respect to the information, the process will be done much quicker and much more efficiently. With the information coming from the information dispatcher together with the translation requests, the Translation Direction Router 1241 identifies all kinds of routing criteria, such as region, time, language direction, etc. It then routes them according to those criteria to different and more oriented investigation processes for quicker, better and targeted reviewing. In addition, the load balancing is done after the routing procedure to ensure the workload is evenly distributed.

The Translation Investigation Router 1242 routes the translation requests according to the information that comes with the requests. Region, language direction, profession identification and other things all affect the routing results. The router applies different routing rules to different services so that different linguists will use different investigation processes.

The Translation Distribution Load-balancer 1244 manages the communication between the router and the investigation platform, using different load-balancing rules for multiple linguist center load-balancing, multiple routing principle load-balancing and load-balancing in other circumstances.

For translation outbursts from users, queuing is inevitable sometimes. Translation flood management, VIP policies, queue length management and other queue priority management are dealt with in the Translation Queuing Management Module 1243.

For all the processes and modules, configuration is very important. For router, the configuration is all about routing policies and criteria. The load-balancer needs load-balancing principles. Queuing management needs specific information about the flood management, VIP policies, etc., for specific services. All routing related rules and configurations could be done in the Translation Routing Rule-set & Configuration 1245 module so that all translation requests and raw results can be delivered to the investigation platform and linguists orderly.

The Translation Engines 1110 module provides machine translation capability. It uses all the information the trigger system sends and provides meaningful results for following processes.

The Translation Engine 1250 here stands for a cluster of different translation engines. The engine trigger in the previous module triggers them. The engine translates the requests automatically. The previous processes have generated and organized quite a collection of information for the machine translation engines to digest, and the information is delivered to the translation engines through the translation trigger process. With the information trigger system gives, the translation engine is able to process the translation requests quickly and with more precision.

Turning now to FIG. 120, Translation results coming out of the translation engines are not always correct, understandable and usable. A certain percentage of the translation results will have to go through manual checking to ensure their quality and accuracy. The Translation Investigation Process 1112 integrates a number of subsystems to help linguists and administrators to investigate, examine and review the translation output from the translation engine with the information provided by the pre-processing modules, In addition, the investigation process and, policies are made and managed within the system. Not only does the Translation Investigation System provide linguists and administrators working platforms to perform, it provides tools for them to perform better at the investigation task. This helps to guarantee the quality of the translation results.

The Translation Investigation Platform 1251 system is mainly for front-end reviewing that is supported by linguists. The system provides a working platform and a standard working process for the linguists, as well as tools and other functions to allow the linguists to do translation reviewing at a very high speed and a high level of precision, so that the translation can be adjusted and corrected without affecting the user expectation of quick and accurate translation service.

Editing Platform for Linguists 1252 is the working platform for reviewing linguists. The platform itself gives a strict working process for linguists to follow. The translation requests deemed to be reviewed would be routed here according to certain principles and checked manually by trained linguists. The platform is based on web and gives linguists the appropriate amount of information from pre-processing modules so that it is easy for them to judge the quality of translation with the additional information without getting overrun by automatically generated information.

The Automatic Spelling & Grammar Correction 1255 module helps to identify the grammatical and spelling errors in the edited translation results as linguists are editing them, gives suggestions to the errors and helps to correct them if specified by the linguists.

The Multilingual Speed Typing Support 1253 module provides support to multilingual speed typing. Whenever a linguist needs to do translation investigation and moreover, correction to the translation results from the machine translation engines, this module helps to make the time spent on typing in different languages minimum.

The Helping Support Flow 1256 module provides a workflow of tiers of supporting experts and supervisors for the linguists so that they can quickly obtain help from supporting colleagues and supervisors. The help-seeking workflow can warn the supervisor who is in need of help and quickly solve the problem. This working flow has been designed into the system, and it requires extra management policies to go with it.

The information, which comes from the pre-processing system, is organized and displayed on the linguist platform as a separate module for linguists to review the search and match results generated by the system. However, for linguists, a comprehensive set of tools just like the pre-processing system but with total control would be more in favor. Together with tiers of support staff, linguists may also use many different search tools and databases to go through large quantities of information to find what they are looking for. In Translation Support Information Display & Advanced Tools 1254, they can use the total search power of the whole system. The system will also help the linguists to get what they want in very short period so that they can finish reviewing very quickly.

Translation outbursts are rapid increase of translation requests from a small group of people in a very short period. The characteristics of translation outbursts include repetitive translation requests, highly resource demanding and favoring time over quality. The Dynamic Translation Database Support 1257 acts as a buffering mechanism for translation outbursts. When an outburst happen, the linguists will be able to see the most recent translation requests from the service in a very short period, for the repetitive nature of the outbursts, they will be able to review much faster.

The Translation Investigation Backend 1258 system is the administrative part of the investigation process. This is where the administrators and supervisors work to make policies, adjust corpuses and execute other administrative work. They observe and control how linguists investigate in the front-end system, as well as control how different services use the modules, tools, databases and linguists on the translation investigation platform. They also control how the investigation modules on the translation process platform are configured and managed as different investigation work may require different modules and different help information may be required for different linguists. For convenience, the entrance to other configuration modules and backends can be found here, as an integrated module.

The Linguist Information Management 1259 platform manages the profiles of the linguists, monitors linguists' work and assigns different properties to linguists. All linguist-related information can be found and modified here, such as which service certain linguist belongs to, which dialect he is good at, etc.

The Investigation Policies Configuration 1263 module, working with a number of subsystems within the pre-processing system and the translation router, helps to analyze, determine and change the investigation policies to fit the current situation. The policies will have to be suitable for high and low translation flows, translation bursts and changing number of linguists, so the policy configuration must be changed accordingly.

The translation requests and results coming in and out of the process can be visualized as translation flow. The Current Translation Flow Monitor System 1260 automatically monitors the translation flow going through the process platform, displays the flow on a chart to whoever wishes to obtain the most current situation of the operating platform and gives out general reports regularly. It also analyzes the data to determine whether an emergency has occurred.

The Service-Resource Allocation 1264 module allocates all resources, especially linguists, according to demands of the services. The demands of the services include message per minute, speed, accuracy, language pair, etc. The human resources will have to carefully planned and allocated in order to be in the most efficient shape.

The In-process Translation Quality Assurance Module 1261 provides the possibility of breaking the translation workflow and inserts a second process of checking and correcting into the normal flow. The module grants the linguists the authorization to check others' reviewing work before the results are sent to users.

The Information Configuration Module 1265 includes system parameter configuration module and service parameter configuration module, such as linguist processing time limit, queue length, white list management, linguist checking result verification, etc.

Intelligent Corpus Training and Optimization 1262 is the special procedure Muuzii creates to collaborate corpus into dictionary and sentence library. As the library grows, the translation speed and accuracy will increase gradually.

When receiving messages to be translated, which does not match with the libraries, they will go to machine translation engine and then go through the linguist platform for verification. Then these should go through Chinese (English) segmentation tool to achieve corpus segmentation. Then by utilizing alignment tool, it will achieve corpus alignment. After processed by best matching tool for phrases, it will goes to auto assessment and goes through linguist verification again to input to Muuzii special standard dictionary library and sentence library.

Other Backend Entrances 1266 provides an integrated entrance to all backends in the whole platform for operational convenience.

Turning now to FIG. 12E, after the investigation process, the translation materials need to be processed one more time. Because both translation requests and investigated translation results are successfully matched at this stage, the post-processing would be necessary to make sure that the matching is natural and sensible. The Post-Processing System 1114 is responsible for after-processing unification and verification, and comparative data analysis is carried out inside the system.

The Linguistic Post-processing System 1267 post-processes all the translation requests that are getting to the Post-processing System 1114, whether they have gone through the investigation process or not, from their linguistic aspects. For some services, extra information needs to be added to the translation requests and results to fit different demands from users. Therefore, the system provides style unification, translation fluidity generation, and extra information addition and the last verification process before going into the access system.

The Style Unification System 1268 uses the Style Library to unify the style of the output translations to give the requesters what they are really going for in terms of style and communication norms. The system will determine whether the translation requests are of a particular style, such as emails, resumes or bills, and process the translation results so that the results will also conform to the same particular style.

The Style Library & Backend 1271 unification system uses the style library here for its task. The backend provided with the library is a tool for the linguists to change the data in the style library.

For services that need extra information to be added or processed after the translation investigation process is done, the Extra Information Addition Process 1274 process provides the means to do so. Currently, the extra information addition process is a standard process with interfaces to other modules that are the actual source of additional information. The three modules, Synonyms & Antonyms, TTS and Pinyin Engine, are now in the platform and the process is able to accept more sources of additional information to be connected to the platform.

In reality, human translators tend to translate differently, using different words to express the same ideas, which is the beauty of language. The Translation Fluidity Generation System 1269 mimics the translation process happening in the real world and helps the platform to generate more natural, varied and fluent translation output. It uses a statistical algorithm to choose a translation result among several matching translation result candidates to make sure that for each time, the translation result is correct and diverse.

The extra information of synonyms and antonyms are stored in the Synonyms & Antonyms Database & Backend 1272 here and the backend provides linguists a tool to modify the entries in the synonyms and antonyms database.

Pinyin & TTS Engine 1275. For users without Chinese character support, pinyin is one of the better ways to read and understand Chinese. The TTS engine provides text to speech service to the whole system as the audio output source. These two are also extra information sources and may be used by the extra information addition process for some services to provide extra information to users who need them.

After the investigation, in the Translation Result Comparison & Scoring 1270 module, translation results from translation engines and human investigation are processed in pairs. The results from these engines, together with the results from our platform, are automatically compared and scored according the standard translation evaluation algorithms and Muuzii translation comparison algorithms. The comparison results and scores are stored for reference.

The Output Verification Process 1273 module verifies, categorizes the translation requests and results, calculates the time spent processing and sends the output to the access system. It applies filtering again to the translation results and records all the necessary statistics regarding the platform and process performance.

Some services may require extra information to be added to the original translation requests and results, but some may not. The Extra Information Addition Process Rule-set 8, Configuration 1276 rule-set gives the process rules for information addition and provides linguists ways to alter and update these rules.

The Mobile Access Adaptor Module 1277 converts the original translation output into forms that are acceptable by mobile protocols. Inside the platform, data are transmitted in texts, when they are to be sent to the users, the module will have to identify the situation the users are in, determine the technical form that is best for the users, and convert the current materials to it. Currently SMS, MMS, Mobile Internet and Application interfaces are supported for cellphone users, and Web is supported for Computer users.

The Real-time Translation Resource Miner 1278 helps to analyze all the translation requests and output in real time. It mines all the linguistic materials to see if they contain any patterns or phenomena worth noticing, and gives out organized data for further resource collecting, policy making and user profiling.

The Product Post-processing Module 1279 helps to post-process all the translation requests and results from the perspective of product refinement. It uses the data the miner generates and does deep analysis in terms of user preferences and behaviors, and also gives instructions on what databases should be then created and what policies should be made for the users.

The User Preference Analysis Module 1280 accepts the data from the miner and analyzes from all aspects of user preferences, such as time, area of interest, translation style etc. This module generates meaningful reports for administrators to get an overview of the users who are using the process platform for a set period.

Translation Resources Gathering Module 1281 is where the dictionaries, databases and corpuses are made initially. This module provides the editors a comprehensive set of tools for resource gathering and library filling, mainly database creation system, editing system and resource importing system.

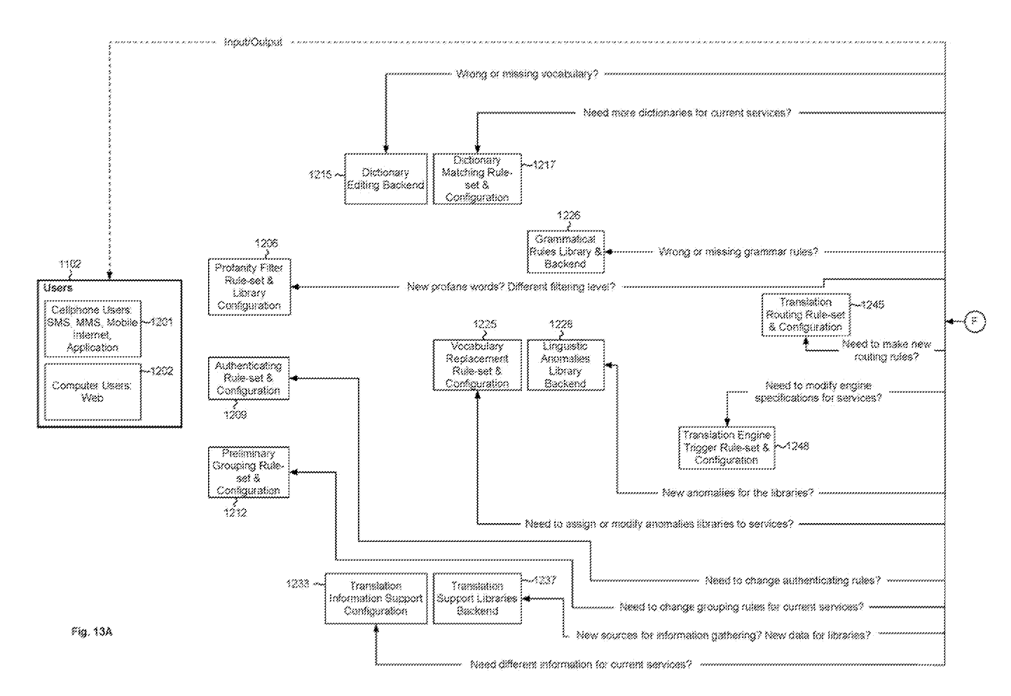

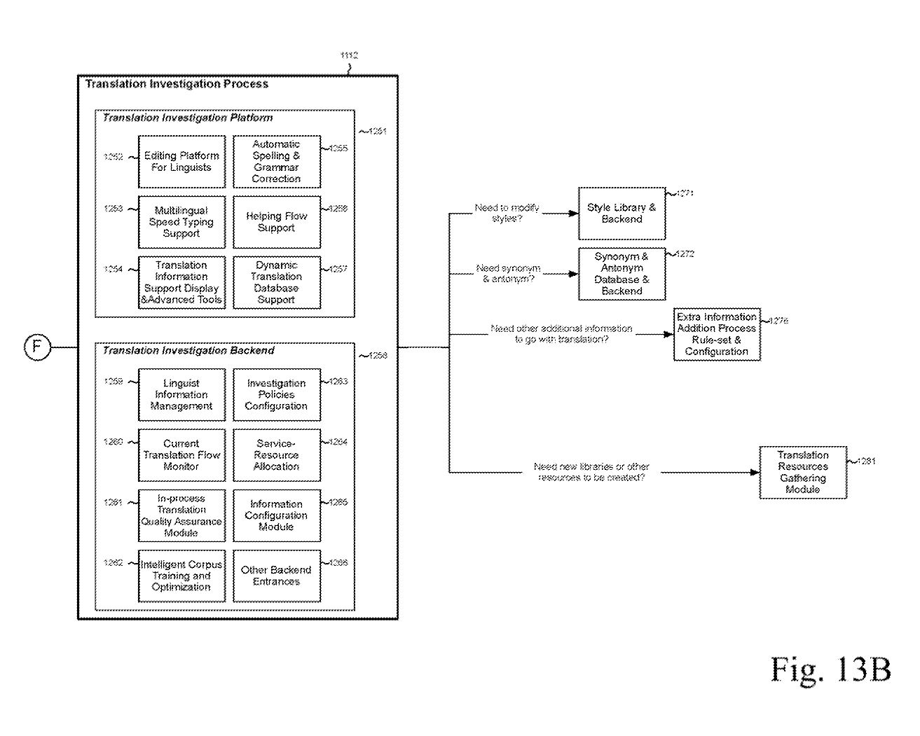

Turning now to FIGS. 13A and 13B, in the most practical live service case, the following Operations Flow Diagram demonstrated our practical process flow and automation that manages incoming request and processes the request. This is accomplished through an intelligent process that delivers the best quality of mobile translation service by combining the automation with live linguistic process to ensure the accuracy and service quality.

Turning for to FIGS. 13A and 13B, the Users 1102 input the text, which is then sent to Translation Investigation Process 1112, previously discussed in FIG. 12D. Translation Investigation Process 1112 uses Dictionary Editing Backend 1215 to check if there is any wrong or missing vocabulary. It further uses Dictionary Matching Rule-set & Configuration 1217 to check if the translation needs more dictionaries for current services. It further uses Grammatical Rules Library & Backend 1226 to check if there are any wrong or missing grammar rules. It further uses Profanity Filter Rule-set & Library Configuration 1206 to check if there are any new profane words, or different filter levels necessary. It further uses Translation Routing Rule-set & Configuration 1245 to check if it needs to make new routing rules. It further uses Translation Engine Trigger Rule-set & Configuration 1248 to check if it needs to modify engine specifications for service. It further uses Linguistic Anomalies Library Backend 1228 to check if there are any new anomalies for the libraries. It further uses Vocabulary Replacement Rule-set & Configuration 1225 to check if it needs to assign or modify anomalies libraries to services. It further uses Authenticating Rule-set & Configuration 1209 to check if it needs to change authenticating rules. It further uses Preliminary Grouping Rule-set & Configuration 1212 to check if it needs to change grouping rules for current services. It further uses Translation Support. Libraries Backend 1237 to check for new sources for information gathering and new data for the libraries. It further uses Translation Information Support Configuration 1233 to check if it needs different information for current services.

Having completed those tasks, Translation Investigation Process 1112 uses Style Library & Backend 1271 to check if it needs to modify the styles. It further uses Synonym & Antonym Database & Backend 1272 to check if it needs anonyms and antonyms. It further uses Extra Information Addition Process Rule-set & Configuration 1276 to check if it needs other addition information to with the translation. It further uses Translation Resources Gathering Module 1281 to check if new libraries or other resources need to be created.

Having completed those tasks, the completed text is sent back to Users 1102.

In summary, the mobile translation, and translation based on mobile learning including language and curriculum learning plus social networks reach are an innovation from the Muuziiers. At Muuzii, we transform mobile learning with easy-to-understand and fun learning. Real-time dynamic, living translation results of machine translation engines, automatic correction, human investigation and other linguistic-related processes and technologies form the core of the Muuzii Translation Process. The Muuzii Translation Process plays a key role in this innovation and provides the basis for our status of pioneer in mobile translation and learning, which is what we call the ‘Muuzii way’.

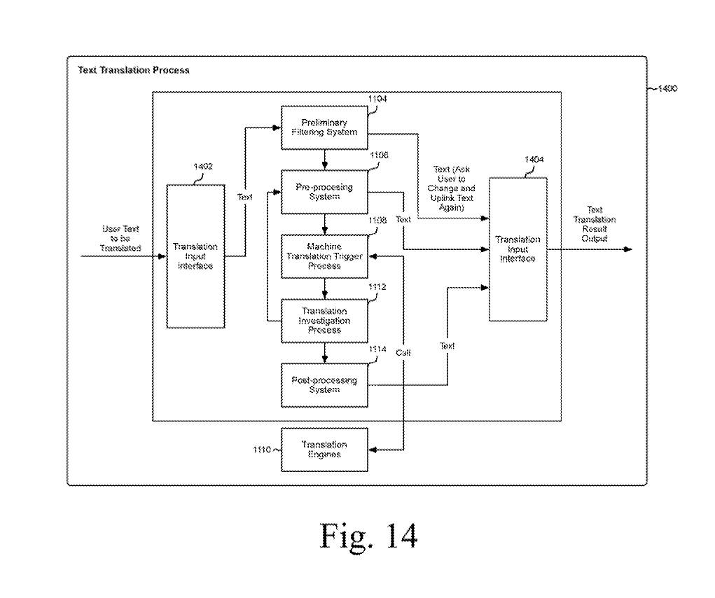

Turning now to FIG. 14, there is shown the Text Translation Process 1400. User Text to be translated is sent to Translation Input Interface 1402, which is sent to the Preliminary Filtering System 1104. The text is then sent to Pro-Processing System 1106 and forwarded on to the Machine Translation Trigger Process 1108. From there, the text goes to Translation Investigation Process 1112 before moving to the Post-processing System 1114. The text is then returned to the user via the Translation Input Interface 1404.

If an error occurs in the Preliminary Filtering System, the text will be rerouted to the user via the Translation Input Interface 1404. If an error is detected in the Pre-processing System 1106, the text will be rerouted to the user via the Translation Input Interface 1404. If an error occurs in the Translation Investigation Process 1112, the text is sent back to Pre-processing System 1106 for further analysis. If a call is received, the Machine Translation Trigger Process 1108 will route the text to the Translation Engines 1110.

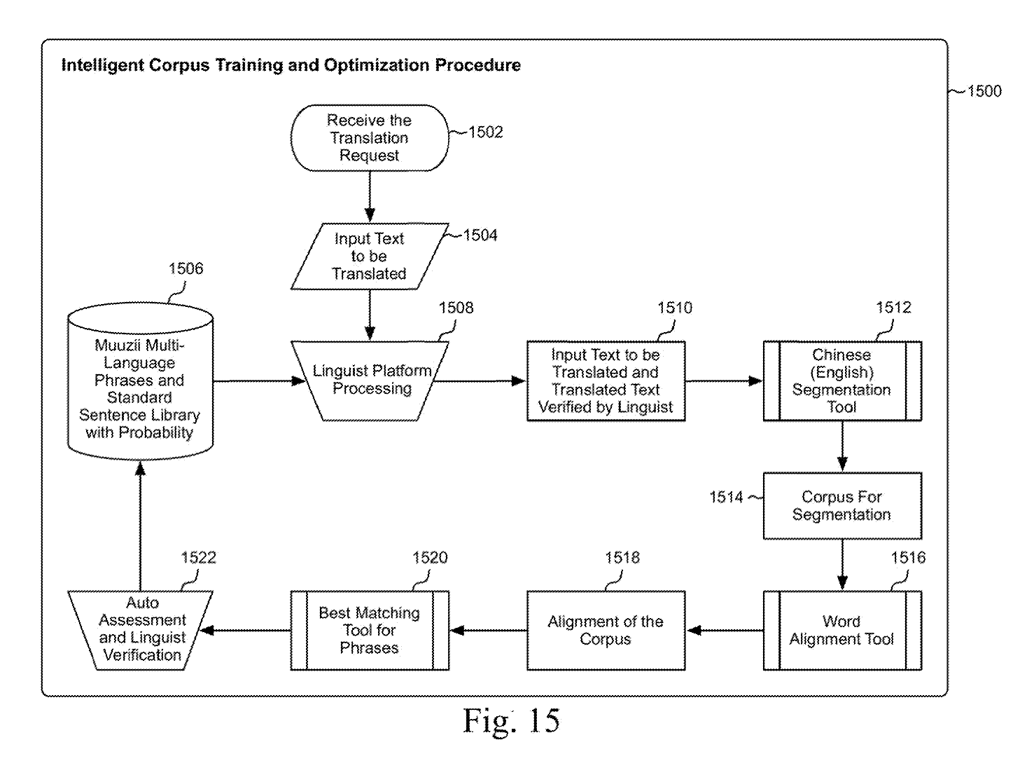

Turning now to FIG. 15, there is show the Intelligent Corpus Training and Optimization Procedure 1500. The procedure begins when request is received via the Receive the Translation Request 1502. The request is then forwarded to process Input Text to be Translated 1504. It is then sent to Linguist Platform Processing 1508, which forwards it to Input Text to be Translated and Translated Text Verified by Linguist 1510. The text is then sent to Chinese (English) Segmentation Tool 1512, which further sends it to Corpus for Segmentation 1514. From there, the text is forwarded to the Word Alignment Tool 1516, then the Alignment of the Corpus 1518 and on to the Best Matching Tool for Phrases 1520. The text is then sent to Auto Assessment and Linguist Verification 1522, which forwards it to Muuzii Multi-Language Phrases and Standard Sentence Library with Probability 1506, which starts the process over again at Linguist Platform Processing 1508.

Voice Translation Process Description. Voice translation process includes several steps: Voice Input/Output Interface Module, Voice Recognition Process Module, Text Translation Process Module, Voice Synthesis Process Module (TTS, Text-to-Speech), The core of voice translation is still the text translation, but adds voice recognition and voice synthesis systems.

Voice Input/Output Interface Module. The voice input interface module receives user's input voice to be translated into Muuzii translation system. After entering the module, the input voice will firstly enter voice recognition system.

The input interface also provides rich/advanced customizable options for users to choose, including personalized parameters, such as speed priority or quality priority.

The voice output interface module deals with the TTS output, after the translation finishes linguist verification, then play the result's audio to the subscriber.

Voice Recognition Process Module. It implements voice recognition for the input voice and achieve the converted text exactly matching with the input voice.

Voice Recognition Engine Trigger Process. For voice translation, when the voice enters the input interface, it will trigger the third party's voice recognition engine to do voice recognition and then convert the input voice into text.

Voice Recognition Evaluation System. Because of dialect, accent, voice speed, word order, background noise, voice recognition could not guarantee the result is completely accurate. The objective of the voice recognition evaluation system is to auto assess if the voice recognition result needs human-machine interactive checking.

Muuzii voice recognition evaluation algorithm is based on several parameters, such as voice recognition engine's confidence provided by the voice recognition engine, sentence grammaticality and integrality, and etc. Then the evaluation system will calculate the assessment result according to the algorithm. If the result is higher than a set threshold, the voice recognition result will go to translation process without human-machine checking. Otherwise, the original voice and converted text will be sent to linguist workstation to make them match.

Voice Recognition Verification Process. Voice translation accuracy depends on voice recognition accuracy and translation accuracy, and either of them should be accurate. Therefore, voice recognition also needs human-machine checking to improve the accuracy.

Voice recognition verification process is implemented through human-machine interactive platform (Linguist Workstation), to achieve the matching between input voice and converted text, or the text will accurately reflect the voice expressed meaning.

On the linguist workstation platform, the converted text of voice recognition will be shown and the original voice will be played, then the linguist could revise the converted text, while listening to the voice. After the checking, the revised text will enter text translation procedure.

Text Translation Process

Voice Synthesis System. For voice translation, when the text translation is accurately achieved, then the voice synthesis engine trigger process will call the third party's Voice Synthesis Engine (Text-To-Speech) to convert the translated text back to voice, so the user could hear the translation result.

Mobile Delivery System. This platform delivers education courseware, translation, mobile digital books and reading materials via a variety of different ways including SMS, MMS, WAP, WEB, APPs and Mobile Internet. Based on mobile Internet, Muuzii also provides services on IP via APP or Web, with the capability of billing through the third party's billing system.

The function of the content delivery system is how the system delivers content to the user required for the appropriate user at the user's desired time. When the user gets personalized service demands, through system scheduling, personalized content will be delivered to the user at the fastest speed.

The functions of content delivery system include:

Personalized Content Delivery Time and Frequency: when the user configures pushing frequency, only when the pushing time occurs, the system will push content to the user. This will minimally interfere with the user's daily study and work. Moreover, the user can also block the system push, and when the user actively uplinks command or messages, the user can still get the language learning content and translation result from the system.

Personalized Content Delivery Method: because the system supports multi-channel delivery, the user can select approaches such as through SMS, MMS, WAP, Web and APP, to receive system push and interactive messages.

User Group Delivery: to improve system efficiency, the system can group users based on user's preference and interactive content. Pushing different content to different group of users, will fully meet the user group's personalized content acquiring demands.

Main Features. Various Service Interfaces. Muuzii Platform includes many methods for integration with service platforms, including database interface, SOCKET Interface, HTTP interface and Web Service interface.

Connection Auto Recovery and Retransmission Mechanism. It supports auto recovery when the gateway fails, and supports retransmission when the transmission fails. The administrator can define the retransmission and reconnection rules.

Traffic Control and Sliding Window Function. Muuzii Platform implements transmission and reception traffic control through management of the sliding window, guaranteeing system stability and high efficiency operation.

Multiple SMS Coding Mechanism. Muuzii Platform supports SMS coding such as UNICODE, GBK, ASCII and Binary. In addition to support for normal text SMS, it also supports picture, ring tone, OTA card writing SMS and ESMS expansion SMS such as Flashing SMS and hands-free SMS.

Compliant with Various Vendor Extension Protocols. Muuzii Platform supports standard protocols and different vendor's Proprietary standards such as standards from AsiaInfo, Huawei, Neusoft, Si-Tech and TSSX. It also supports different versions of the same protocol for access at the same time.

Auto Load Balance and Distributed Deployment. Muuzii Platform supports deploying the same gateway on multiple servers and providing clustering capabilities to achieve redundancy and scalability.

Remote Management Configuration (RMC). RMC via Web is another key feature of the Muuzii Platform providing easy access and configuration management via Web to achieve higher efficiency.

Multiple Databases Supported. Muuzii Platform supports multiple databases including MS SQL Server, Oracle, MySQL and MongoDB.

Routing Control. Muuzii Platform supports key word and service code combination methods to provide accurate and fuzzy matching approach to implement the routing control.

MMS Features, Muuzii Platform supports: Image, voice and text mixed compiling; Generating content via MMS templates; over 500 KB MMS; Status Report function; Query MMS delivery status.

Delivery Gateway and System Modules

The delivery process is completed by employing various types of gateway interfaces with Mobile operators, such as SMS, MMS, WAP, Web, APP and IP for Mobile Internet.

Operator Gateway. Muuzii gateway system is capable of accessing most of the largest operators' gateway in the world, such as China Mobile, China Telecom and China Unicorn in China, and AT&T in United States.

For China Mobile, Muuzii connects with China Mobile's SMS, MMS, WAP, Web, and APP gateway and provides many types of services, such as translation and language course services, study aid resources searching and digital mobile publishing. Muuzii supports several thousand SMS per second push to the subscribers, which makes it easy for Muuzii to support millions of subscribers.

For AT&T Wireless, Muuzii connects with AT&T SMS, MMS, Payment API (Speech API in the future), and provides various services to AT&T subscribers and through standard AT&T home billing system, Muuzii Service can be billed as a regular mobile purchase on an individual home monthly bill.

Messaging Integrator Gateway. There are many messaging Aggregators in the United States that who could access various carriers' gateway such as SMS, MMS and WAP. Through messaging Aggregator platform, Muuzii is able to provide services via different operators at the same time. Muuzii platform is capable of connecting and interface with Aggregator, such as OpenMarket and SAP sybase365.

Internet Gateway. Muuzii platform not only supports SMS, MMS services via carriers, but it could provide services on Mobile Internet via APP and Web. Supported by the third party billing system such as PayPal and prepay systems, Muuzii can charge the mobile Internet subscribers as well.

SMS/MMS Gateway Access System. Gateway access system consists of five sub modules that connect with operators SMS and MMS gateway center, then processing transceiving SMS and/or MMS. Here are some of the highlights:

SMS/MMS Gateway Parameter Configuration Module: It configures the gateway access parameter setting with the operators, including short code, subscriber name, password and call back address.

SMS/MMS Gateway Service Management Module: It configures the parameters of value added services running on operator's gateway.

SMS/MMS Gateway Operation Monitoring Module: It monitors and controls the communication between Muuzii and the SMS/MMS gateway/center.

SMS/MMS Gateway Log Management Module: It records the gateway platform operation logs for daily maintenance.

SMS/MMS Traffic Statistics Module: It gets statistics of gateway system's SMS/MMS traffic.

Service Distribution System. Service Distribution System distributes the services to corresponding subscribers, six of the modules in this sub system work seamlessly to ensure that the distribution of the service is accurate and efficient:

Service Request Processing Module: Responsible for receiving and processing service requests from communication platform.

Service Analysis Request Module: Deals with the services requests' unified analysis for configured services and gateway data.

Certificate Authentication Request Module: Judges the validity of the subscriber's service request and the requested service.

Content Filtering Request Module: Determines if the subscriber's uplink content is legitimate or reasonable. If not, the system will notify the subscriber to change the uplink content and try again.

Service Submit Request Module: Delivers the subscriber's service request to the service system.

Service Request Routing Module: According to the analysis for the subscriber's service request, routes the subscriber's service request to corresponding service processing system.

Authentication and Verification System. Authentication and Verification System is responsible for verifying if the subscriber has the authority to use Muuzii services.

Subscriber Module: It, processes subscriber's service subscription and cancellation.

Group Management Module: Based on subscribers' status, it will group the subscribers and deal with their pushing and responding operation together.

Management Module: It configures the Black list and White list for each service.

Subscriber Permission Management Module: It determines if the subscriber has the permission to process the operation, according to his or her status and the subscribed service status.

Batch Subscriber Activation Module: For a batch of subscribers, it will conduct the activation and cancellation operation.

Subscriber Authorization Function Module: This module will determine if the subscriber belongs to Muuzii service.

Service Authentication Function Module: This is a module that will determine the subscriber subscribes to Muuzii services.

Billing System: The Muuzii billing system is designed to deal with the billing related issues with the operators:

Billing Policy Configuration Module: It configures the billing policy, such as monthly pay, per message pay or free.

Billing Service Interface Module: For communication system, it is the interface to initialize billing request.

Billing Report Management Module: Manages all the billing reports.

Billing Statistics Module: Processes the statistics for billing reports.

Billing Report Generation Module: Generates billing reports for all the subscribers and the operator if needed. This is also important for revenue authentication and verification between Muuzii and Operators.

Muuzii Content Delivery Process, Muuzii UMLP 124 will deliver the service contents to the corresponding subscribers as they desire. The contents could be the translation results or the mobile learning contents pushing to the subscribers or interact with them.

When a subscriber subscribes to any Muuzii mobile service, Muuzii delivers the service content to the subscriber according to the service rules. Generally speaking, Muuzii offers two types of services: one is mobile translation service, and the other is mobile learning service. Mobile translation service is a mobile unique text service for the subscriber to uplink a message to be translated, Muuzii translation platform will response the translation result back to the subscriber. The mobile learning service however, offers learning series courses that, when a subscriber subscribes to the service, the service will push the content to the subscriber based on mobile learning theory and the service rules. Then the subscriber can interact with the mobile learning system to get more learning content or take a weekly quiz to evaluate the learning progress.

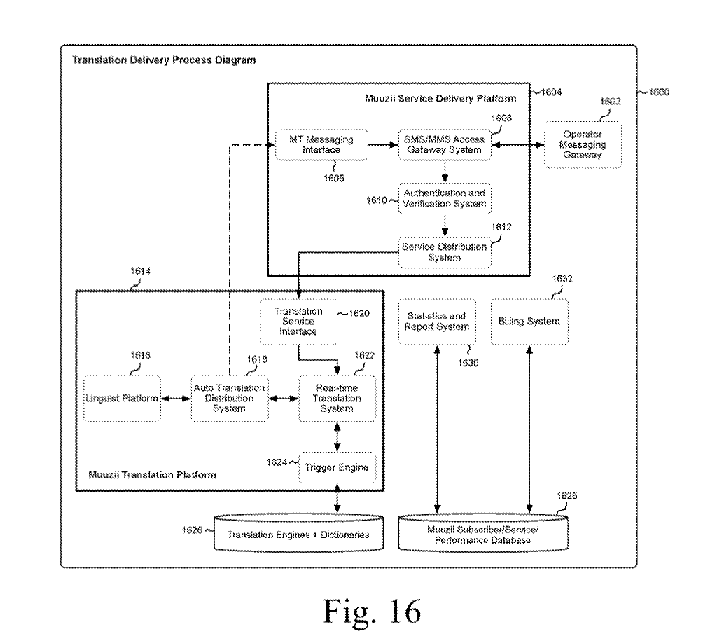

Turning now to FIG. 16, the Translation Delivery Process 1600 is an interactive service and the subscriber will initiate the original message to be translated, and the translation system will reply the accurate translation result.

The subscriber should subscribe the translation service firstly.

When subscriber uplink message to be translated to the translation service short code, the Operator Messaging Gateway 1602 will pass it to SMS/MMS Access Gateway System 1608 after the verification from the operator that the subscriber had subscribed the service.

Then Authentication and Verification System 1610 will verify if the subscriber already subscribed the service and if the translated message quantity exceeded the service's allowance. If not, it indicates that the translation request could be processed by the translation system.

Then Service Distributed System 1612 will distribute it to the corresponding translation service interface.

There are two multiple language-pair translation solutions Muuzii supports:

First, if all the translation services are on single short code, the service will provide a menu (The subscriber could uplink help to get the menu) listing all language pairs supported, and the subscriber could select the desired language pair. Then no matter which language message is uplinked, Muuzii will auto recognize the language type and send the request to real-time translation system.

Then if the translation services are on different short codes, then no need for subscriber to select translation language pair, Muuzii translation system will auto recognize the uplink language type in the pair and send the request to the Real-Time Translation System 1622.

If the uplink message to be translated matches the bilingual standard sentence library or dictionary library, the translation result of the library will be directly send to Auto Translation Distribution System 1618, then to MT Messaging Interface 1606 to send translation result back to the subscriber.

Otherwise, the Real-time Translation System 1622 will call the third party machine Translation Engine and Dictionary 1626 to get machine translation result.

Then the machine translation result will be sent to Auto Translation Distribution System 1618 to assign it to a Linguist Platform 1616. If all the linguists are busy, the message will be put in the waiting queue, otherwise the message will be auto sent to one linguist selected by system rules, such as linguist language level, dialect linguist, etc.

The queue is based on first-in-first-out mechanism; however, if the subscriber's mobile number is in the white list, which indicates he should has higher priority getting the service, and then his message will be served first.

Linguist will implement machine translation verification in a setting time, assisted by a set of tools provided by the linguist workstation platform. Through the human-machine interactive checking, the translation result will be accurate and the translation speed will be 5 times faster comparing with pure human translation.

After the verification, in post-processing system, one word will be selected from the English (or other language) sentence whether English is original language or target language, then the word's explanation, together with its synonyms and antonyms will be added following the translation result. In this way, the subscriber will get more knowledge in addition to the translation.

Because some of US phones do not support Chinese characters, so if the target language is Chinese, then the translation result should be converted into MMS. Here Muuzii will also add Pinyin (indicating Chinese pronunciation) and the Chinese pronunciation audio to the translation result in the MMS to enhance the language study effect.

The translation result will be sent to MT messaging interface, in either SMS or MMS format. Then through SMS/MMS gateway, the translation result will be delivered to the operator's gateway, then send to the subscriber.

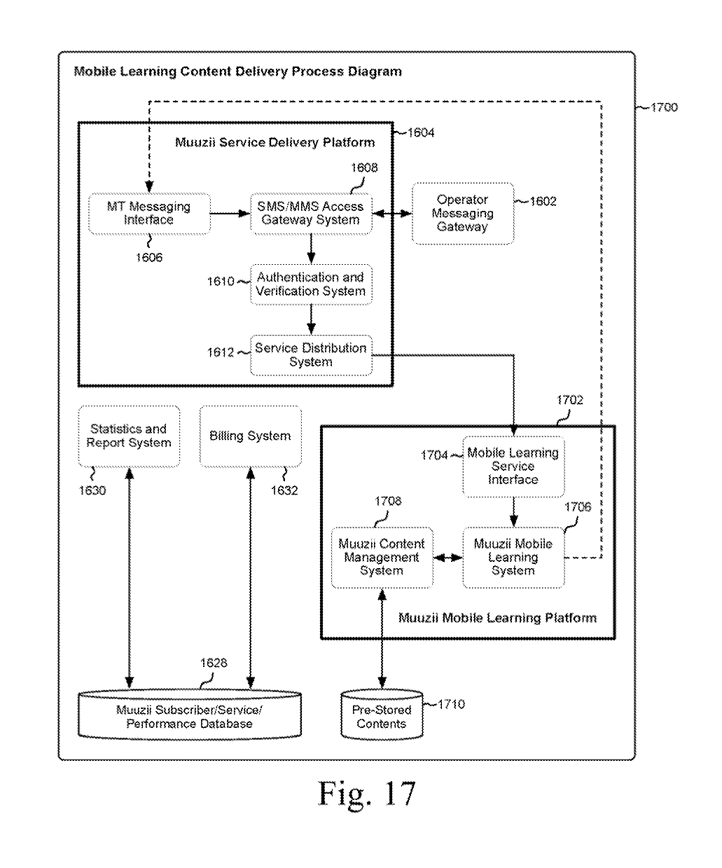

Turning now to FIG. 17, Mobile Learning Content Delivery Process 1700, Muuzii mobile learning services generally are content pushing services, combined with content interactive process for subscribers who would like to get more learning contents or attend quiz to evaluate the learning effect.

First, the subscriber should subscribe the mobile learning service.

When a subscriber subscribes one mobile learning service, the system database will record the subscription time, his content pushing date according to the service rules, and his learning progress. On each day, the system will check who should get the pushing content, loading the learning content or the quiz from the pre-stored content database, then pushing the corresponding content to the subscribers terminal through MT Messaging Interface 1606, SMS/MMS Access Gateway System 1608 of Muuzii and operator's messaging gateway. Therefore, the subscriber will receive the mobile learning materials on schedule.

The subscriber also could configure the pushing time by himself, such as in the morning or in the afternoon, and then Muuzii will deliver the content to the subscriber at his desired period. By providing personalized service, it will improve the user experience and increase user loyalty.

When the subscriber needs more learning content he could uplink a text command to get more content, or reply the quiz to evaluate the study effect.

For mSpeak service which will be described below, the system will push the quiz to the subscriber on a scheduled date, and after the subscriber reply the questions in the required format, the system will review the answers and send the quiz score to the subscriber, so he could learn the lessons again to improve the learning efficiency if the score is not good.

For mLearn service described below, when subscriber reply 1, 2, 3, 4 or 5 individually, each time he could get two bilingual language learning sentences.

For each mobile learning service, Muuzii will develop special schema and process to deliver the service content to the subscribers.

Here we will describe mSpeak language learning process for AT&T.

mSpeak process is to make sure it runs properly every day, and the system should provide the right content to the right user on schedule, and could interact with the right user for question answering and scoring.

According to the user's mobile num. subscribed service, lesson and quiz pushing progress, Muuzii will push the right lesson and quiz to the user on time. For example, when a user subscribes to mSpeak Chinese course, mSpeak will push lesson 1 at once to the user and on the fourth day and sixth day, will push lesson 2 and the 1st quiz to the user, then with 7 days a cycle. mSpeak will record each user's learning progress and memorize their quiz score, then at the end of the course, Muuzii will evaluate the learning effect of the user.

With Mobile Number, Short Code and Content, mSpeak will push corresponding lesson and quiz to the user on schedule.

While the invention has been described in connection with preferred embodiments, it is not intended to limit the scope of the invention to the particular form set forth, but on the contrary, it is intended to cover such alternatives, modifications, and equivalents as may be included within the spirit and scope of the invention as defined by the attached claims.

We claim:

1. A translation system for sending messages over a telecommunication pathway comprising:
a first text SMS transmission sent by a user on a transmission path of a telecommunication provider in a first language received by a server;
a comparison database on said server of a second language for matching with said transmission in said first language;
a converter in said database for converting said transmission into a second language upon making said match;
a translator for converting said first transmission into said second language if no match is made into a second transmission;
a processor in said server for analyzing said conversion of said transmission for accuracy; and
a data path for said second transmission on said carrier for said telecommunication provider to send said transmission to said user.

2. A translation system as claimed in claim 1 further comprising delivery of a translated message to a user of said first transmission.

3. A translation system as claimed in claim 1 further comprising delivery to said user a teaching lesson on a pre-determined timed basis.

4. A translation system as claimed in claim 1 further comprising delivery to said user of at least one of the following: reading materials, exercises, activities, tests or quizzes.

5. A translation system as claimed in claim 1 further comprising a dictionary of phrases for matching between two languages.

6. A translation system as claimed in claim 1 further comprising an interactive dictionary that adds words or phrases through artificial intelligence.

7. A computerized translation system comprising:
a server for reception of a message to be translated over a telecommunication pathway;
a language module on said server that configures a first and second language pair for machine translation;
a language calling module that calls translation language modules on said server for matching of said language pairs;
a real-time translator on a server that translates said message from a source language text to target language text;
a translation evaluator that checks the accuracy of each translation result to make sure a serviceable translation; and
a message delivery of said translation result to a user.

8. A translation system as claimed in claim 7 wherein said telecommunication pathway is an SMS/MMS gateway.

9. A translation system as claimed in claim 7 further comprising a human-machine interactive platform to provide translation verification.

10. A translation system as claimed in claim 7 further comprising an interactive dictionary of words or phrases based on user input.

11. A translation system as claimed in claim 7 further comprising delivery from said server to said user of at least one of the following: reading materials, exercises, activities, tests or quizzes.

12. A translation system as claimed in claim 7 further comprising a pre-processor on said server that recognizes linguistic irregularities, including lexical errors, misspellings, syntactical errors and synonyms and modifies said irregularities to conform to said second language's pre-stored standard grammar.

13. A translation system as claimed in Maim 7 further comprising delivery of language lessons on a pre-determined timed basis.

14. A computerized translation method on an SMS/MMS gateway comprising:
translating a message delivered to a server from a user through an SMS/MMS gateway between two languages to recognize a first language message and translate it into a target second language;
pre-processing on said server that recognizes linguistic irregularities, including lexical errors, misspellings, syntactical errors and synonyms and modifies said irregularities to conform to said second language's pre-stored standard grammar;
delivery of said machine translated message to a human linguist platform for post verification that operates on said machine translation for review; and
delivery to the SMS/MMS gateway of said finished translation to said user.

15. A translation method as claimed in claim 14 further comprising the step of providing a human-machine interactive platform to provide translation verification.

16. A translation method as claimed in claim 14 further comprising the step of delivering language lessons on a pre-determined timed basis.

17. A translation method as claimed in claim 14 further comprising the step of delivering to said user at least one of the following: reading materials, exercises, activities, tests or quizzes.

18. A translation method as claimed in claim 14 further comprising the step of adding words or phrases to an interactive dictionary based on user input.

19. A translation method as claimed in claim 14 further comprising the step of matching stored words and phrases from said second language with said user input in said first language.

20. A translation method as claimed in claim 14 further comprising the step of receiving third party content for teaching lessons.
